(19) United States
(12) Patent Application Publication
(10) Pub. No.: US 2007/0225423 A1
(43) Pub. Date: Sep. 27, 2007

(54) Process for producing blow molded product by blow molding

(75) Inventors: Hirotaka Uosaki, Ichihara-shi (JP); Kuniaki Kawabe, Ichihara-shi (JP); Motoyasu Yasui, Chiba-shi (JP)

Correspondence Address: BUCHANAN, INGERSOLL & ROONEY PC, POST OFFICE BOX 1404, ALEXANDRIA, VA, 22313-1404, US

(73) Assignee: Mitsui Chemicals, Inc., Minato-ku (JP)

(21) Appl. No.: 11/730,286

(22) Filed: Mar. 30, 2007

Related U.S. Application Data
(63) Continuation-in-part of application No. 11/543,165, filed on Oct. 5, 2006.
(60) Provisional application No. 60/738,583, filed on Nov. 22, 2005.

(30) Foreign Application Priority Data
Oct. 7, 2005 (JP) 2005-295664

(51) Int. Cl. C08L 91/08

(52) U.S. Cl. 524/487

(57) ABSTRACT

Provided is a process for efficiently producing a molded product with an improved moldability in blow molding and no deterioration of the physical properties of the molded product. The process comprises melting a mixture of a thermoplastic resin and a polyolefin wax which has a number-average molecular weight (Mn) in terms of polyethylene, as measured by gel permeation chromatography (GPC), in the range of 200 to 5,000, and a crystallization temperature, as measured by a differential scanning calorimetry (DSC), in the range of 65 to 120° C.; and then subjecting the mixture to blow molding.

### BACKGROUND OF THE INVENTION

1. Field of the Invention

The present invention relates to a process for producing a molded product, and more specifically to a process for producing a molded product which comprises melting a mixture of a thermoplastic resin and a polyolefin wax and then subjecting the mixture to blow molding.

2. Description of the Related Art

From the past, blow molding is known as one of the processes for preparing a molded product from thermoplastic resins such as polyolefin resins, and has been employed in the preparation of containers such as bottles and tanks, architectural materials such as external walls, automobile parts such as automobile exterior parts, industrial machinery parts, electrical and electronic parts, and the like.

In recent years, there is a need of a process for improving the productivity of blow molding without deterioration of various physical properties of the molded article.

For example, there have been carried out investigations on a molding machine for blow molding, or a process for improving the productivity of the molding by modifying the molding conditions (see, for example, JP-A-11-254512, and Pamphlet of WO 97/45246).

However, there is still a need of a process for improving the productivity of molding without deterioration of various physical properties of the molded article, even with no use of special molding machines or molding conditions, and the conventional processes need further improvement on the productivity.

In addition, as the common method of improving the productivity of molding such as blow molding, there has been known a method of molding with the addition of an auxiliary agent for molding. For example, there has been an investigation on a method of molding by applying an auxiliary agent for molding such as oil and polyethylene wax to a thermoplastic resin which to be molded (see, for example, JP-B-5-80492 and JP-T-2003-528948).

However, when thermoplastic resins such as polyolefin resins are blow molded with the use of the conventional auxiliary agent for molding, although the moldability itself tends to show an improvement, the properties of the obtained molded product, e.g., mechanical properties, may be deteriorated in some cases. Thus, there may arise in problems depending on the application although the auxiliary agent is attempted to be used for a molded product.

### SUMMARY OF THE INVENTION

It is an object of the present invention to provide a process for efficiently producing a molded product with an improved moldability in blow molding, without deterioration of the physical properties of the molded product.

It is an another object of the invention to provide a process for producing a molded product of a polyolefin resin with an improved productivity of blow molding, without deterioration of the mechanical properties originally possessed by polyolefin resins.

The present inventors have earnestly studied to overcome the above-described problems, and as a result, they have found that: improvement on the moldability in blow molding and efficient production of a molded article without deterioration of properties of the molded article can be accomplished by melting a mixture of a thermoplastic resin and a specific polyolefin wax, and then subjecting the mixture to blow molding for producing a molded product; and improvement on the productivity of the blow molding and a molded product with no deteriorated mechanical properties originally possessed by a thermoplastic resin such as polyolefin resin can be obtained by using a thermoplastic resin such as polyolefin resin and a specific polyolefin wax each as a raw material, and then subjecting the materials to blow molding. Thus, they have completed the invention.

That is, the process for producing a molded product according to the invention is characterized in that it comprises melting a mixture of a thermoplastic resin (A) and a polyolefin wax (B) which has a number-average molecular weight (Mn) in terms of polystyrene in the range of 400 to 5,000, and a crystallization temperature, as measured by a differential scanning calorimetry (DSC), in the range of 65 to 120° C., and then subjecting the mixture to blow molding.

Also, the process for producing a molded product according to the invention is characterized in that it comprises melting a mixture of a thermoplastic resin (A) and a polyolefin wax (B) which has a number-average molecular weight (Mn) in terms of polyethylene in the range of 200 to 5,000, and a crystallization temperature, as measured by a differential scanning calorimetry (DSC), in the range of 65 to 120° C., and then subjecting the mixture to blow molding.

The polyolefin wax (B) is preferably a polyethylene wax, and more preferably a metallocene polyethylene wax.

Further, the process for producing a molded product according to the invention is characterized in that it comprises blow molding a mixture of a thermoplastic resin (A) and a polyethylene wax which has a density, as measured by a density gradient tube process in accordance with JIS K7112, in the range of 890 to 980 kg/m³, and a number-average molecular weight (Mn) in terms of polyethylene, as measured by gel permeation chromatography (GPC), in the range of 500 to 3,000, and satisfies the relationship shown by the following formula (I):
B≦0.0075×K (I),
in the formula (I), B is a proportion (wt%) of components contained in the polyethylene wax each having a molecular weight in terms of polyethylene, as measured by gel permeation chromatography, of 20,000 or more; and K is a melt viscosity (mPa·s) of the polyethylene wax at 140° C.

The polyethylene wax further preferably satisfies the relationship shown by the following formula (II):
A≦230×K^{(-0.537)} (II),
in the formula (II), A is a proportion (wt%) of components contained in the polyethylene wax each having a molecular weight in terms of polyethylene, as measured by gel permeation chromatography, of 1,000 or less; and K is a melt viscosity (mPa·S) of the polyethylene wax at 140° C.

According to the present invention, a molded product can be efficiently obtained by blow molding without deteriorating the physical properties of the molded product, and this process provides excellent moldability.

Further, according to the process for producing a molded product of the invention, an excellent productivity in blow molding a thermoplastic resin such as polyolefin resin can be obtained. Herein, a molded product of a thermoplastic resin such as a polyolefin resin which can be obtained by blow molding is not deteriorated in its mechanical properties which are originally possessed by the thermoplastic resin.

### DESCRIPTION OF PREFERRED EMBODIMENTS

Hereinbelow, the present invention will be described in detail.

First, the raw materials used for blow molding of the invention will be described.

Thermoplastic resin (A):

The thermoplastic resin (A) according to the invention refers to a thermoplastic polymer having a number-average molecular weight (Mn) in terms of polystyrene, as measured by gel permeation chromatography (GPC), of 8,000 or more, or a blend thereof.

The thermoplastic resin (A) used in the invention is not particularly limited, but examples thereof include polyolefins such as a low-density polyethylene, a medium-density polyethylene, a high-density polyethylene, a linear low-density polyethylene, polypropylene, a cyclic olefin polymer, an ethylene-propylene copolymer, and a cyclic olefin copolymer;

styrene polymers such as polystyrene, an acrylonitrile-styrene copolymer, and an acrylonitrile-butadiene-styrene copolymer;

polyvinyl chloride, polyvinylidene chloride;

an ethylene-methacrylic acid copolymer, an ethylene-methacrylic acid ester copolymer, an ethylene-vinyl acetate copolymer, an ethylene-vinyl alcohol copolymer;

polycarbonate, polymethacrylate;

polyesters such as polyethylene terephthalate and polybutylene terephthalate;

polyamides such as Nylon 6, Nylon 11, Nylon 12, Nylon 46, Nylon 66, Nylon MXD6, wholly-aromatic polyamide, and semi-aromatic polyamide;

polyacetal, and a blend of these resins.

Among these thermoplastic resins, polyolefin resin is preferable; low-density polyethylene, medium-density polyethylene, high-density polyethylene, linear low-density polyethylene, polypropylene, and an ethylene-propylene copolymer are more preferable; and high-density polyethylene and polypropylene are even more preferable.

If the thermoplastic resin (A) is the above-described resin, the dispersity with the polyolefin wax (B) is excellent, and thus, a good molded product, for example, a molded product with no surface tackiness can be obtained.

In addition, if the thermoplastic resin (A) is the above-described resin, the dispersity with the polyolefin wax (B) is excellent, effect of improving the fluidity is large, and the molding rate significantly increases, and thus a surface tackiness-free molded product can be obtained.

The polyolefin resin according to the invention generally refers to a polyolefin resin useful for blow molding, which can be exemplified by polyethylene such as low-density polyethylene, medium-density polyethylene, high-density polyethylene, and a linear low-density polyethylene, polypropylene, an ethylene-propylene copolymer, or a blend of these resins.

Polyethylene

The above-mentioned polyethylene specifically refers to a homopolymer of ethylene, a copolymer of ethylene and a small amount of α-olefin, or a blend thereof, and its MI, measured under the conditions of a temperature of 190° C. and a test load of 21.18 N in accordance with JIS K7210, usually is in the range of 0.01 to 100 g/10 min.

As the polyethylene, a high-density polyethylene with the density in the range of 940 to 980 (kg/m³) or a blend thereof; or polyethylenes with the density in the range of 900 (kg/m³) or more to less than 940 (kg/m³), such as a low-density polyethylene, a medium-density polyethylene, a linear low-density polyethylene, and a very low-density polyethylene, or a blend of these, may be mentioned.

In the invention, the conditions for measuring the MI and density of polyethylene are as follows.

MI:

The MI is measured under conditions of a temperature of 190° C. and a test load of 21.18 N in accordance with JIS K7210.

Density:

The density is measured by a density gradient tube process in accordance with JIS K7112.

The MI (JIS K7210; 190° C., a test load of 2.16 kgf) of the high-density polyethylene is preferably in the range of 0.01 to 1.0 g/10 min, and more preferably in the range of 0.01 to 0.80 g/10 min.

With the MI of the high-density polyethylene in the above range, a molded product which is excellent in texture, rigidity, impact strength, chemical resistance, or the like, may be obtained.

The density of the above polyethylene is preferably in the range of 942 to 970 kg/m³, more preferably in the range of 944 to 965 kg/m³.

With the density of the polyethylene in the above range, a molded product which is excellent in texture, rigidity, impact strength, chemical resistance, or the like, may be obtained.

The form of polyethylene is not particularly limited, but is generally in a pellet form or a tablet form.

Polypropylene

The above-mentioned polypropylene specifically refers to a homopolymer of propylene, a copolymer of propylene and an a-olefin (excluding propylene), or a blend thereof, and its MI, measured under the conditions of a temperature of 230° C. and a test load of 21.18 N in accordance with JIS K7210, usually is in the range of 0.01 to 100 g/10 min. Specific examples of the polypropylene may include a propylene homopolymer, a polypropylene block copolymer prepared by copolymerizing propylene with an a-olefin (excluding propylene), a polypropylene random copolymer, and a blend of these.

In the invention, the conditions for measuring the MI of polypropylene are as follows.

MI:

The MI is measured under conditions of a temperature of 230° C. and a test load of 21.18 N in accordance with JIS K7210.

The MI (JIS K7210; 230° C., a test load of 2.16 kgf) of the polypropylene is preferably in the range of 0.1 to 3.5 g/10 min, and more preferably in the range of 0.4 to 1.5 g/10 min.

With the MI of the polypropylene in the above range, a molded product which is excellent in heat resistance, chemical resistance, or the like, may be obtained.

The form of polypropylene is not particularly limited, but is generally in a pellet form or a tablet form.

Polyolefin Wax (B):

In the invention, the polyolefin wax (B) is added to the thermoplastic resin (A) for use. In the invention, the polyolefin wax refers to a polyolefin polymer having a number-average molecular weight in terms of polyethylene in the range of 200 to 5,000.

The polyolefin wax (B) preferably has a crystallization temperature, as measured by a differential scanning calorimetry (DSC) under the condition of a temperature lowering rate of 2° C./min, in the range of 65 to 120° C., and a number-average molecular weight (Mn), as measured by gel permeation chromatography (GPC), in the range of 200 to 5,000 in terms of polyethylene, and in the range of 400 to 5,000 in terms of polystyrene. When the polyolefin wax is added to the thermoplastic resin (A), and the mixture is melted and then subject to blow molding, the melt viscosity of the resin is lowered, and thus the load of the motor upon extrusion is reduced, as well as the fluidity is improved, thus the molding rate being increased. Further, the surface of the molded product is improved, and thus a molded product having a smooth surface can be obtained. Further, the molding can be effected at a low molding temperature, thus leading to a reduced cooling time, and an improved molding cycle, as well as to a suppression of thermal deterioration of the resin, burning and black speck of the resin, and thus excellent mechanical strength of the molded product can be obtained.

The number-average molecular weight (Mn) of 400 to 5,000 in terms of polystyrene is synonymous with the number-average molecular weight (Mn) of 200 to 2,500 in terms of polyethylene.

The number-average molecular weight is determined by GPC measurement. The conditions for the measurement are the followings.

The number-average molecular weight in terms of polystyrene is a value determined by the measurement under the following conditions with the use of a calibration curve obtained by using commercially available monodispersed polystyrene as a standard.

The number-average molecular weight in terms of polyethylene is a value determined by converting the number-average molecular weight in terms of polystyrene measured in the above manner according to the following calibration method.

Device: Alliance Gel Permeation Chromatography, GPC 2000 (manufactured by Waters)

Solvent: o-dichlorobenzene

Column: TSKgel column×4 (manufactured by Tosoh Co., Ltd)

Flow rate: 1.0 ml/min

Sample: 0.15 mg/ml o-dichlorobenzene solution

Temperature: 140° C.

Molecular weight Conversion: in terms of PE/universal calibration method

For the universal calibration method, the following coefficient of Mark-Houwink viscosity equations are used. The coefficient of polystyrene (PS): KPS=1.38×10⁻⁴, aPS=0.70 The coefficient of polyethylene (PE): KPE=5.06×10⁻⁴, aPE=0.70

The polyolefin wax (B) used in the invention is not particularly limited, but examples thereof include a wax of an ethylene homopolymer, a polypropylene wax, a wax of an α-olefin homopolymer, a wax of an ethylene/α-olefin copolymer, a wax of an ethylene/α-olefin/non-conjugated diene copolymer, and the like.

Among these polyolefin waxes, polyethylene waxes such as a wax of an ethylene homopolymer and a wax of an ethylene/α-olefin copolymer are preferable; a wax of an ethylene homopolymer and a wax of a copolymer of ethylene and an α-olefin having 3 to 20 carbon atoms are more preferable; a wax of an ethylene homopolymer, a wax of an ethylene/propylene copolymer, a wax of an ethylene/1-butene copolymer, a wax of an ethylene/1-pentene copolymer, a wax of an ethylene/1-hexene copolymer, a wax of an ethylene/4-methyl-1-pentene copolymer, and a wax of an ethylene/1-octene copolymer are even more preferable; a wax of an ethylene homopolymer, a wax of an ethylene/propylene copolymer, a wax of an ethylene/1-butene copolymer, a wax of an ethylene/1-hexene copolymer, and a wax of an ethylene/4-methyl-1-pentene copolymer are particularly preferable.

If the polyolefin wax (B) is the above-described polyolefin wax, the dispersity with the thermoplastic resin (A), particularly with the polyolefin resin is excellent, and thus, a good molded product, for example, a molded product with no surface tackiness can be obtained.

The polyolefin wax (B) has a number-average molecular weight (Mn) in terms of polystyrene, as measured by gel permeation chromatography (GPC), in the range of preferably 400 to 5,000, more preferably 700 to 4,500, more particularly preferably 800 to 4,000.

With the Mn of the polyolefin wax (B) in the above range, there are provided such the effects as increased improvement on the fluidity, and greatly increased molding rate.

In the present invention, the polyolefin wax (B) may also preferably have a molecular weight in terms of polyethylene, as measured by gel permeation chromatography (GPC), in the range of greater than 2,500 to 5,000.

Therefore, in another embodiment of the invention, the polyolefin wax (B) has a number-average molecular weight (Mn) in terms of polyethylene, in the range of preferably 200 to 5,000, more preferably 400 to 5,000.

With the Mn of the polyolefin wax (B) in the above range, there are provided such the effects as increased improvement on the fluidity, and greatly increased molding rate.

The ratio (Mw/Mn) of the weight-average molecular weight to the number-average molecular weight, as measured by gel permeation chromatography (GPC), is in the range of preferably 1.5 to 4.0, more preferably 1.5 to 3.5.

With the Mw/Mn of the polyolefin wax (B) in the above range, a molded product with no surface tackiness can be obtained.

The polyolefin wax (B) has a crystallization temperature, as measured by a differential scanning calorimetry (DSC) under the condition of a temperature lowering rate of 2° C./min., preferably in the range of 65 to 120° C., more preferably in the range of 70 to 120° C., and particularly preferably in the range of 70 to 118° C.

With the crystallization temperature of the polyolefin wax (B) in the above range, a molded product with no surface tackiness can be obtained.

The density of the polyolefin wax (B), as measured by a density gradient tube process in accordance with JIS K7112, is in the range of preferably 850 to 980 kg/m³, more preferably 870 to 980 kg/m³, and even more preferably 890 to 980 kg/m³.

With the density of the polyolefin wax in the above range, the molding shrinkage of the molded product can be easily regulated.

Further, the polyolefin wax (B) satisfies the following relationship represented preferably by the following formula (III), more preferably the following formula (IIIa), and even more preferably the following formula (IIIb), of the crystallization temperature [Tc (° C.)], as measured by a differential scanning calorimetry (DSC), and the density (D (kg/m³)), as measured by a density gradient tube process:
0.501×D−366≧Tc (III)
0.501×D−366.5≧Tc (IIIa)
0.501×D−367≧Tc (IIIb)

If the crystallization temperature (Tc) and the density (D) of the polyolefin wax (B) satisfies the above formula, for example, if the polyolefin wax (B) is a wax of an ethylene/α-olefin copolymer and the compositional distribution of the copolymer is uniform, the tackiness of the molded product obtained by blow molding the mixture comprising the thermoplastic resin (A) and the polyolefin wax (B) tends to reduce.

The penetration hardness of the polyolefin wax (B), as measured in accordance with JIS K2207, is usually 30 dmmor less, preferably 25 dmm or less, more preferably 20 dmm or less, and even more preferably 15 dmm or less.

With the penetration hardness of the polyolefin wax (B) in the above range, a molded product having sufficient rigidity can be obtained.

The acetone extraction quantity of the polyolefin wax (B) is in the range of preferably 0 to 20% by weight, more preferably 0 to 15% by weight.

The acetone extraction quantity is measured in the following manner.

In a Soxhlet's extractor (made of glass), a filter (ADVANCE, No. 84) is used, and 200 ml of acetone is introduced into a 300 ml round-bottom flask in the lower part. Extraction is carried out in a hot-water bath at 70° C. for 5 hours. 10 g of the first wax is set on the filter.

The polyolefin wax (B) is a solid at room temperature, and is a low-viscosity liquid at a temperature between 65 to 130° C.

With the acetone extraction quantity of the polyolefin wax (B) in the above range, the content of the tacky components is decreased, and the fouling of the mold is suppressed, as well as a molded product with no surface tackiness can be obtained.

The process for producing the polyolefin wax (B) is not particularly limited, but the polyolefin wax (B) can be obtained, for example, by the polymerization of monomers such as ethylene, an α-olefin, and the like, using a Ziegler/Natta catalyst or a metallocene catalyst. Among these catalysts, a metallocene catalyst to be described later is preferable.

Polyethylene Wax

A polyethylene wax preferably used as the polyolefin wax (B) of the invention will be described further.

The polyethylene wax according to the invention refers to a homopolymer of ethylene or a copolymer of ethylene and an α-olefin, having a number-average molecular weight (Mn) in terms of polyethylene, as measured by gel permeation chromatography (GPC), in the range of 200 to 5,000, preferably 500 to 3,000, or a blend thereof. The number-average molecular weight (Mn) of the aforementioned polyethylene wax given in terms of polyethylene is determined in the same manner as above by the gel permeation chromatography (GPC) measurement under the following conditions.

Number-Average Molecular Weight (Mn):

The number-average molecular weight is determined by GPC measurement. The conditions for the measurement are the followings. The number-average molecular weight is determined with the use of a calibration curve obtained by using commercially available monodispersed polystyrene as a standard according to the following calibration method.

Device: Alliance Gel Permeation Chromatography, GPC 2000 (manufactured by Waters)

Solvent: o-dichlorobenzene

Column: TSKgel column×4 (manufactured by Tosoh Co., Ltd)

Flow rate: 1.0 ml/min

Sample: 0.15 mg/ml o-dichlorobenzene solution

Temperature: 140° C.

Molecular weight Conversion: in terms of PE/universal calibration method

For the universal calibration method, the following coefficients of Mark-Houwink viscosity equations are used. The coefficient of polystyrene (PS): KPS=1.38×10⁻⁴, aPS=0.70 The coefficient of polyethylene (PE): KPE=5.06×10⁻⁴, aPE=0.70

If the polyethylene wax has the composition and the molecular weight as above, the productivity in molding tends to improve.

The density of the polyethylene wax used in the invention is in the range of 890 to 980 (kg/m³). The density of the polyethylene wax is a value measured by a density gradient tube process in accordance with JIS K7112. If the density of the polyethylene wax is in the above range, the productivity in molding tends to improve.

The polyethylene wax of the invention preferably satisfies the relationship between the molecular weight and the melt viscosity shown by the following formula (I):
B≦0.0075×K (I),
in the formula (I), B is a proportion (wt%) of components contained in the polyethylene wax each having a molecular weight in terms of polyethylene, as measured by gel permeation chromatography, of 20,000 or more; and K is a melt viscosity (mPa·S), as measured by Brookfield viscometer (B type), of the polyethylene wax at 140° C.

If the polyethylene wax satisfying the above formula (I) is used, the molded product obtained tends to have no deteriorated mechanical properties originally possessed by the thermoplastic resin. In particular, if the thermoplastic resin is a polyolefin resin, the tendency is greatly increased.

When a mixture of a thermoplastic resin such as a polyolefin resin and a polyethylene wax with a low melt viscosity is blow molded, the productivity in molding usually tends to improve due to the lowered viscosity of the whole mixture. However, although the productivity is improved like so, there still is a case where the molded product thus obtained has no sufficient mechanical properties.

According to the investigation made by the present inventors, they have found that, for the mechanical properties of the molded product obtained by blow molding such as sheets and films, the proportion of the components having the molecular weight of 20,000 or more in the used polyethylene wax is very important in relation to a melt viscosity. Its detailed mechanism is not yet clarified, but it is assumed that if the proportion of the components having the molecular weight of 20,000 or more is not set under a constant degree, the polyethylene wax cannot be well dispersed in a thermoplastic resin, particularly in a polyolefin resin, thereby affecting the mechanical properties of the finally obtained molded product. Thus, when melt-kneading a polyethylene wax with a thermoplastic resin, particularly with a polyolefin resin, the proportion of the components having the molecular weight of 20,000 or more has to be set under a certain degree, from the viewpoints of the whole polyethylene wax, because a melting behavior of the components having the molecular weight of 20,000 or more is specific among the whole polyethylene wax.

The polyethylene wax having a B value of above range can be prepared with the use of a metallocene catalyst. Among the metallocene catalysts, a metallocene catalyst having a non-bridged ligand is preferable. As such metallocene catalyst, a metallocene compound represented by the formula (1) which will be shown later can be exemplified.

The B value may be controlled by a polymerization temperature. For example, when the polyethylene wax is produced with the use of a metallocene catalyst described later, the polymerization temperature is usually in the range of 100 to 200° C., but from the viewpoint of producing the polyethylene wax having the above B value, the polymerization temperature is in the range of preferably 100 to 180° C., and more preferably 100 to 170° C.

The polyethylene wax of the invention further preferably satisfies the relationship between the molecular weight and the melt viscosity shown by the following formula (II):
A≦230×K^{(-0.537)} (II)
in the formula (II), A is a proportion (wt%) in weight standard of components contained in the polyethylene wax each having a molecular weight in terms of polyethylene, as measured by gel permeation chromatography, of 1,000 or less; and K is a melt viscosity (mPa·S) of the polyethylene wax at 140° C.

If the polyethylene wax satisfying the above formula (II) is used, the molded product obtained tends to have no deteriorated mechanical properties originally possessed by the thermoplastic resin, and also a bleeding out to the surface of the molded product tends to decrease. In particular, if the thermoplastic resin is a polyolefin resin, the tendencies are greatly increased.

When a mixture of a thermoplastic resin such as a polyolefin resin and a polyethylene wax with a low melt viscosity is blow molded, the productivity in molding usually tends to improve due to the lowered viscosity of the whole mixture. However, although the productivity is improved like so, there still are cases where the mechanical properties originally possessed by the thermoplastic resin such as a polyolefin resin are deteriorated and where bleeding out to the surface of the molded product arises as the problem.

According to the investigation made by the present inventors, they have found that, for the mechanical properties or the like of the molded product obtained by blow molding such as sheets and films, the proportion of the components having the molecular weight of 1,000 or less in the used polyethylene wax is very important in relation to a melt viscosity. Its detailed mechanism is not yet clarified, but it is assumed that if the proportion of the components having the molecular weight of 1,000 or less is not set under a certain degree, a weeping of the wax to the surface of the molded product or a deterioration in some cases may be caused, thereby becoming effective on the mechanical properties of the finally obtained molded product or on the bleeding out to the surface. Thus, when melt-kneading a polyethylene wax with a thermoplastic resin, particularly with a polyolefin resin, the proportion of the components having the molecular weight of 1,000 or less has to be set under a certain degree, from the viewpoints of the whole polyethylene wax, because the components having a molecular weight of 1,000 or less are easily melted and a melting behavior of the components is specific among the whole polyethylene wax.

The polyethylene wax having an A value of above range can be prepared with the use of a metallocene catalyst. Among the metallocene catalysts, a metallocene catalyst having a non-bridged ligand is preferable. As such metallocene catalyst, a metallocene compound represented by the formula (1) which will be shown later can be exemplified.

The A value may be controlled by a polymerization temperature. For example, when the polyethylene wax is produced with the use of a metallocene catalyst described later, the polymerization temperature is usually in the range of 100 to 200° C., but from the viewpoint of producing the polyethylene wax having the above A value, the polymerization temperature is in the range of preferably 100 to 180° C., and more preferably 100 to 170° C.

The number-average molecular weight (Mn) in terms of polyethylene of the polyethylene wax is preferably in the range of 500 to 3,000, and more preferably in the range of 1,500 to 3,000.

If the number-average molecular weight (Mn) of the polyethylene wax is in the above range, a dispersion of the polyethylene wax in a thermoplastic resin, particularly in a polyolefin resin, upon molding tends to improve. Further, an improvement on the extrusion amount, a reduction in the load upon extrusion, and an improvement on the productivity are more likely to be obtained. Moreover, the mechanical properties of the obtained molded product are unlikely deteriorated as compared to the molded product prepared in the absence of the polyethylene wax.

The Mn of the polyethylene wax may be controlled by a polymerization temperature or the like. For example, when the polyethylene wax is produced with the use of a metallocene catalyst described later, the polymerization temperature is usually in the range of 100 to 200° C., but from the viewpoint of producing the polyethylene wax having the Mn of above preferred range, the polymerization temperature is in the range of preferably 100 to 180° C., and more preferably 100 to 170° C.

The density (D (kg/m³)) of the polyethylene wax is preferably in the range of 890 to 980 (kg/m³).

When the polyethylene wax is a homopolymer of ethylene, the density of the polyethylene wax is dependent on the number-average molecular weight (Mn) of the polyethylene wax. For example, at a low molecular weight of the polyethylene wax, the density of the polymer to be obtained can be lowered. When the polyethylene wax is a copolymer of ethylene and α-olefin, the density of the polyethylene wax is dependent on the size of the number-average molecular weight (Mn), and may be controlled in accordance with the amount of α-olefin used based on ethylene upon polymerization and kinds of the α-olefin used. For example, an increase in the amount of α-olefin used based on ethylene may reduce the density of a polymer to be obtained.

In terms of the density of the polyethylene wax, an ethylene homopolymer, preferred are a copolymer of ethylene and α-olefin having 3 to 20 carbon atoms, and a blend of these.

As the α-olefin used for producing the copolymer of ethylene and α-olefin having 3 to 20 carbon atoms, an α-olefin having 3 to 10 carbon atoms is preferable; propylene, 1-butene, 1-pentene, 1-hexene, 4-methyl-1-pentene, and 1-octene are more preferable; and propylene, 1-butene, 1-hexene, and 4-methyle-1-pentene are particularly preferable.

The α-olefin used for producing the copolymer of ethylene and α-olefin is preferably in the range of 0 to 20 mol % based on a total monomer used.

The density of polyethylene wax may be controlled by a polymerization temperature. For example, when the polyethylene wax is produced with the use of a metallocene catalyst described later, the polymerization temperature is usually in the range of 100 to 200° C., but from the viewpoint of producing the polyethylene wax having the density of above preferred range, the polymerization temperature is in the range of preferably 100 to 180° C., and more preferably 100 to 170° C.

Such polyethylene wax is a solid at room temperature, and is a low-viscosity liquid at a temperature between 65 to 130° C.

Further, the polyethylene wax satisfies the following relationship represented preferably by the following formula (IV), more preferably the following formula (IVa), and even more preferably the following formula (IVb), of the crystallization temperature [Tc (° C.)], as measured by a differential scanning calorimetry (DSC), and the density (D (kg/m³)), as measured by a density gradient tube process:
0.501×D−366≧Tc (IV)
0.501×D−366.5≧Tc (IVa)
0.501×D−367≧Tc (IVb).

If the crystallization temperature (Tc) and the density (D) of the polyethylene wax satisfy the above formula, the dispersion of the polyethylene wax in a thermoplastic resin such as polyolefin resin tends to improve.

The polyethylene wax satisfying the relationship represented by the above-mentioned formulae can be prepared, for example, with the use of a metallocene catalyst. Among the metallocene catalysts, a metallocene catalyst having a non-bridged ligand is preferable. As such metallocene catalyst, a metallocene compound represented by the formula (1) which will be shown later can be exemplified.

The polyethylene wax satisfying the relationship represented by the above-mentioned formulae may also be prepared by controlling a polymerization temperature. For example, when the polyethylene wax is produced with the use of a metallocene catalyst described later, the polymerization temperature is usually in the range of 100 to 200° C., but from the viewpoint of producing the polyethylene wax having the above B value, the polymerization temperature is in the range of preferably 100 to 180° C., and more preferably 100 to 170° C.

In the invention, an example of the metallocene catalyst used for the production of polyolefin wax such as polyethylene wax includes a catalyst for olefin polymerization comprising:

(A) a metallocene compound of a transition metal selected from Group 4 of the periodic table, and

(B) at least one compound selected from:
(b-1) an organoaluminum oxy-compound,
(b-2) a compound which reacts with the bridged metallocene compound (A) to form an ion pair, and
(b-3) an organoaluminum compound.

Hereinbelow, each of the components will be described in detail.

Metallocene Compound:

(A) Metallocene Compound of Transition Metal selected from Group 4 of the Periodic Table

The metallocene compound for forming the metallocene catalyst is a metallocene compound of a transition metal selected from Group 4 of the periodic table, and a specific example thereof is a compound represented by the following formula (1):
M¹Lₓ (1)

In the above formula, M¹ is a transition metal selected from Group 4 of the periodic table, x is a valence of the transition metal M¹, and L is a ligand. Examples of the transition metals indicated by M¹ include zirconium, titanium and hafnium. L is a ligand coordinated to the transition metal M¹, and at least one ligand L is a ligand having cyclopentadienyl skeleton. This ligand having cyclopentadienyl skeleton may have a substituent. Examples of the ligands L having cyclopentadienyl skeleton include a cyclopentadienyl group; alkyl or cycloalkyl substituted cyclopentadienyl groups, such as a methylcyclopentadienyl group, an ethylcyclopentadienyl group, an n-or i-propylcyclopentadienyl group, an n-, i-, sec-, or t-butylcyclopentadienyl group, a dimethylcyclopentadienyl group, a methylpropylcyclopentadienyl group, a methylbutylcyclopentadienyl group, and a methylbenzylcyclopentadienyl group; an indenyl group; a 4,5,6,7-tetrahydroindenyl group; a fluorenyl group; and the like. In these ligands having cyclopentadienyl skeleton, hydrogen may be replaced with a halogen atom, a trialkylsilyl group, or the like.

When the metallocene compound has two or more ligands having cyclopentadienyl skeleton as the ligand L, two of the ligands having cyclopentadienyl skeleton may be bonded to each other through an alkylene group, such as ethylene or propylene, a substituted alkylene group, such as isopropylidene or diphenylmethylene, a silylene group, or a substituted silylene group, such as dimethylsilylene, diphenylsilylene or methylphenylsilylene.

The ligand L other than the ligand having cyclopentadienyl skeleton (ligand having no cyclopentadienyl skeleton) is, for example, a hydrocarbon group having 1 to 12 carbon atom(s); an alkoxy group; an aryloxy group; a sulfonic acid-containing group (—SO₃R¹), wherein R¹ is an alkyl group, an alkyl group substituted with a halogen atom, an aryl group, an aryl group substituted with a halogen atom, or an aryl group substituted with an alkyl group; a halogen atom; or a hydrogen atom.

Example 1 of Metallocene Compound:

When the metallocene compound represented by the above formula (1) has a transition metal valence of, for example, 4, this metallocene compound (1) is more specifically represented by the following formula (2):
R²ₖR³₁R⁴ₘR⁵ₙM¹ (2)

wherein M¹ is a transition metal selected from Group 4 of the periodic table, R² is a group (ligand) having cyclopentadienyl skeleton, and R³, R⁴ and R⁵ are each independently a group (ligand) having or not having cyclopentadienyl skeleton, k is an integer of 1 or greater, and k+1+m+n=4.

Examples of the metallocene compounds having zirconium as M¹ and having at least two ligands having cyclopentadienyl skeleton include bis (cyclopentadienyl) zirconium monochloride monohydride, bis(cyclopentadienyl)zirconium dichloride, bis(1-methyl-3-butylcyclopentadienyl)zirconium-bis(trifluoromethanesulfonate), bis(1,3-dimethylcyclopentadienyl)zirconium dichloride, and the like.

Also employable are compounds wherein the 1,3-position substituted cyclopentadienyl group in the above compounds is replaced with a 1,2-position substituted cyclopentadienyl group.

As another example of the metallocene compound, a metallocene compound of bridge type wherein at least two of R², R³, R⁴ and R⁵ in the formula (2), e.g., R² and R³, are groups (ligands) having cyclopentadienyl skeleton and these at least two groups are bonded to each other through an alkylene group, a substituted alkylene group, a silylene group, a substituted silylene group, or the like is also employable. In this case, R⁴and R⁵ are each independently the same as the aforesaid ligand L other than the ligand having cyclopentadienyl skeleton.

Examples of the metallocene compounds of bridge type include ethylenebis(indenyl)dimethylzirconium, ethylenebis(indenyl)zirconium dichloride, isopropylidene(cyclopentadienyl-fluorenyl)zirconium dichloride, diphenylsilylenebis (indenyl) zirconium dichloride, methylphenylsilylenebis(indenyl)zirconium dichloride, and the like.

Example 2 of Metallocene Compound:

Another example of the metallocene compound is a metallocene compound represented by the following formula (3) that is described in JP-A No. 4-268307.

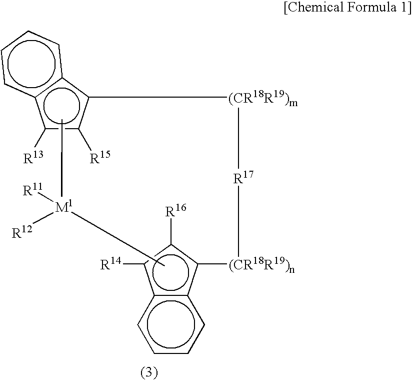

In the above formula, M¹ is a transition metal of Group 4 of the periodic table, specifically titanium, zirconium, or hafnium.

R¹¹ and R¹² may be the same as or different from each other and are each a hydrogen atom, an alkyl group having 1 to 10 carbon atom(s), an alkoxy group having 1 to 10 carbon atom(s), an aryl group having 6 to 10 carbon atoms, an aryloxy group having 6 to 10 carbon atoms, an alkenyl group having 2 to 10 carbon atoms, an arylalkyl group having 7 to 40 carbon atoms, an alkylaryl group having 7 to 40 carbon atoms, an arylalkenyl group having 8 to 40 carbon atoms, or a halogen atom. R¹¹ and R¹² are each preferably a chlorine atom.

R¹³ and R¹⁴ may be the same as or different from each other and are each a hydrogen atom, a halogen atom, an alkyl group having 1 to 10 carbon atom(s) which may be halogenated, an aryl group having 6 to 10 carbon atoms, or a group of —N(R²⁰)₂, —SR²⁰, —OSi(R²⁰)₃, —Si(R²⁰)₃, or —P(R²⁰)₂. R²⁰ is a halogen atom, preferably a chlorine atom, an alkyl group having 1 to 10, preferably 1 to 3 carbon atom(s), or an aryl group having 6 to 10, preferably 6 to 8 carbon atoms. R¹³ and R¹⁴ are each particularly preferably a hydrogen atom.

R¹⁵ and R^{1 6}are the same as R¹³and R¹⁴, except that a hydrogen atom is not included, and they may be the same as or different from each other, preferably the same as each other. R¹⁵and R¹⁶ are each preferably an alkyl group having 1 to 4 carbon atom(s) which may be halogenated, specifically methyl, ethyl, propyl, isopropyl, butyl, isobutyl, trifluoromethyl or the like, particularly preferably methyl.

In the formula (3), R¹⁷ is selected from the following group.

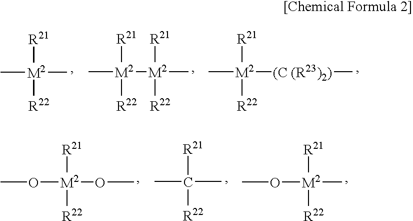

═BR²¹, ═AlR²¹, —Ge—, —Sn—, —O—, —S—, ═SO, ═SO₂, ═NR²¹, ═CO, ═PR²¹, ═P(O)R²¹, etc. M² is silicon, germanium or tin, preferably silicon or germanium. R²¹, R²² and R²³ may be the same as or different from one another and are each a hydrogen atom, a halogen atom, an alkyl group having 1 to 10 carbon atom(s), a fluoroalkyl group having 1 to 10 carbon atom(s), an aryl group having 6 to 10 carbon atom, a fluoroaryl group having 6 to 10 carbon atoms, an alkoxy group having 1 to 10 carbon atom(s), an alkenyl group having 2 to 10 carbon atoms, an arylalkyl group having 7 to 40 carbon atoms, an arylalkenyl group having 8 to 40 carbon atoms, or an alkylaryl group having 7 to 40 carbon atoms. ‘R²¹ and R²²’ or ‘R²¹ and R²³’ may form a ring together with atoms to which they are bonded. R¹⁷ is preferably ═CR²¹R²², ═SiR²¹R²², GeR²¹R²², —O—, —S—, ═SO, ═PR²¹, or ═P(O)R²¹. R¹⁸ and R¹⁹ may be the same as or different from each other and are each the same atom or group as that of R²¹. m and n may be the same as or different from each other and are each 0, 1 or 2, preferably 0 or 1, and m+n is 0, 1 or 2, preferably 0 or 1.

Examples of the metallocene compounds represented by the formula (3) include rac-ethylene(2-methyl-1-indenyl)₂-zirconium dichloride, rac-dimethylsilylene (2-methyl-1-indenyl)₂-zirconium dichloride, and the like. These metallocene compounds can be prepared by, for example, a process described in JP-A No. 4-268307.

Example 3 of Metallocene Compound:

As the metallocene compound, a metallocene compound represented by the following formula (4) is also employable.

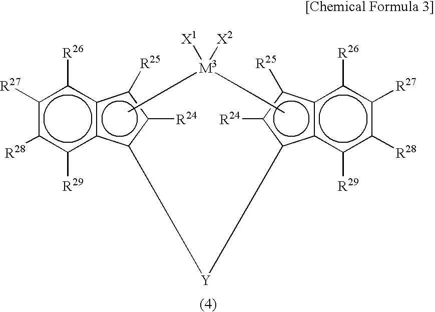

In the formula (4), M³ is a transition metal atom of Group 4 of the periodic table, specifically titanium, zirconium, or hafnium. R²⁴ and R²⁵ may be the same as or different from each other and are each a hydrogen atom, a halogen atom, a hydrocarbon group having 1 to 20 carbon atom(s), a halogenated hydrocarbon group having 1 to 20 carbon atom(s), a silicon-containing group, an oxygen-containing group, a sulfur-containing group, a nitrogen-containing group, or a phosphorus-containing group. R²⁴ is preferably a hydrocarbon group, particularly preferably an alkyl group having 1 to 3 carbon atom(s), i.e., methyl, ethyl or propyl. R²⁵ is preferably a hydrogen atom or a hydrocarbon group, particularly preferably a hydrogen atom or an alkyl group having 1 to 3 carbon atom(s), i.e., methyl, ethyl, or propyl. R²⁶, R²⁷, R²⁸ and R²⁹ may be the same as or different from one another and are each a hydrogen atom, a halogen atom, a hydrocarbon group having 1 to 20 carbon atom(s), or a halogenated hydrocarbon group having 1 to 20 carbon atom(s) Of these, preferable is a hydrogen atom, a hydrocarbon group or a halogenated hydrocarbon group. At least one combination of “R²⁶ and R²⁷”, “R²⁷ and R²⁸”, and “R²⁸ and R²⁹” may form a monocyclic aromatic ring together with carbon atoms to which they are bonded. When there are two or more hydrocarbon groups or halogenated hydrocarbon groups other than the groups that form the aromatic ring, they may be bonded to each other to form a ring. When R²⁹ is a substituent other than the aromatic group, it is preferably a hydrogen atom. X¹ and X² may be the same as or different from each other and are each a hydrogen atom, a halogen atom, a hydrocarbon group having 1 to 20 carbon atom(s), a halogenated hydrocarbon group having 1 to 20 carbon atom(s), an oxygen-containing group, or a sulfur-containing group. Y is a divalent hydrocarbon group having 1 to 20 carbon atom(s), a divalent halogenated hydrocarbon group having 1 to 20 carbon atom(s), a divalent silicon-containing group, a divalent germanium-containing group, a divalent tin-containing group, —O—, —CO—, —S—, —SO—, —SO₂—, —NR³⁰—, —P(R³⁰)—, —P(O)(R³⁰)—, —BR³⁰— or —AlR³⁰— (R³⁰ is a hydrogen atom, a halogen atom, a hydrocarbon group having 1 to 20 carbon atom(s), or a halogenated hydrocarbon group having 1 to 20 carbon atom(s)).

Examples of the ligands in the formula (4) which have a monocyclic aromatic ring formed by mutual bonding of at least one combination of “R²⁶ and R²⁷”, “R²⁷ and R²⁸”, and “R²⁸ and R²⁹” and which are coordinated to M³ include those represented by the following formulas:

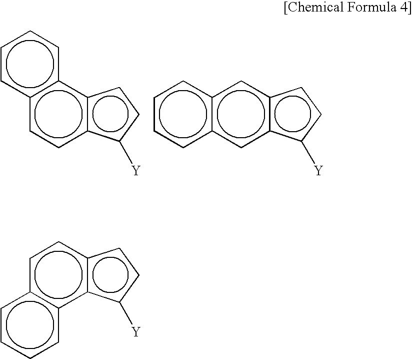

(wherein Y is the same as that described in the above-mentioned formula).

Example 4 of Metallocene Compound:

As the metallocene compound, a metallocene compound represented by the following formula (5) is also employable.

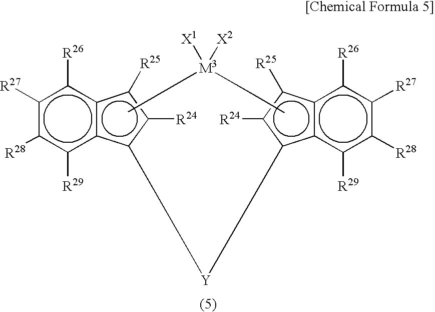

In the formula (5), M³, R²⁴, R²⁵, R²⁶, R²⁷, R²⁸, and R²⁹ are the same as those in the formula (4). Of R²⁶, R²⁷, R²⁸ and R²⁹, two groups including R²⁶ are each preferably an alkyl group, and R²⁶ and R²⁸, or R²⁸ and R²⁹ are each preferably an alkyl group. This alkyl group is preferably a secondary or tertiary alkyl group. Further, this alkyl group may be substituted with a halogen atom or a silicon-containing group. Examples of the halogen atoms and the silicon-containing groups include substituents exemplified with respect to R²⁴ and R²⁵. Of R²⁶, R²⁷, R²⁸, and R²⁹, groups other than the alkyl group are each preferably a hydrogen atom. Two groups selected from R²⁶, R²⁷, R²⁸, and R²⁹ may be bonded to each other to form a monocycle or a polycycle other than the aromatic ring. Examples of the halogen atoms include the same atoms as described with respect to R²⁴ and R²⁵. Examples of X¹, X² and Y include the same atoms and groups as previously described.

Specific examples of the metallocene compounds represented by the formula (5) include:

rac-dimethylsilylene-bis(4,7-dimethyl-1-indenyl)zirconium dichloride, rac-dimethylsilylene-bis(2,4,7-trimethyl-1-indenyl)zirconium dichloride, rac-dimethylsilylene-bis(2,4,6-trimethyl-1-indenyl)zirconium dichloride, and the like.

Also employable are transition metal compounds wherein the zirconium metal is replaced with a titanium metal or a hafnium metal in the above compounds. The transition metal compound is usually used as a racemic modification, but R form or S form is also employable.

Example 5 of Metallocene Compound:

As the metallocene compound, a metallocene compound represented by the following formula (6) is also employable.

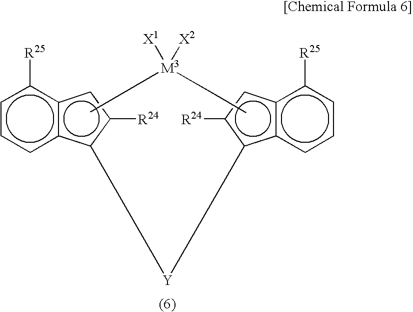

In the formula (6), M³, R²⁴, X¹, X², and Y are the same as those in the formula (4). R²⁴ is preferably a hydrocarbon group, particularly preferably an alkyl group having 1 to 4 carbon atom(s), i.e., methyl, ethyl, propyl, or butyl. R²⁵ is an aryl group having 6 to 16 carbon atoms. R²⁵ is preferably phenyl or naphthyl. The aryl group may be substituted with a halogen atom, a hydrocarbon group having 1 to 20 carbon atom(s), or a halogenated hydrocarbon group having 1 to 20 carbon atom(s) X¹ and X² are each preferably a halogen atom or a hydrocarbon group having 1 to 20 carbon atom(s).

Specific examples of the metallocene compounds represented by the formula (6) include:

rac-dimethylsilylene-bis(4-phenyl-1-indenyl)zirconium dichloride, rac-dimethylsilylene-bis(2-methyl-4-phenyl-1-indenyl)zirconium dichloride, rac-dimethylsilylene-bis(2-methyl-4-(α-naphthyl)-1-indenyl)zirconium dichloride, rac-dimethylsilylene-bis(2-methyl-4-(β-naphthyl)-1-indenyl)zirconium dichloride, rac-dimethylsilylene-bis(2-methyl-4-(1-anthryl)-1-indenyl)zirconium dichloride, and the like. Also employable are transition metal compounds wherein the zirconium metal is replaced with a titanium metal or a hafnium metal in the above compounds.

Example 6 of Metallocene Compound:

As the metallocene compound, a metallocene compound represented by the following formula (7) is also employable.
LaM⁴X³₂ (7)

In the above formula, M⁴is a metal of Group 4 or lanthanide series of the periodic table. La is a derivative of a delocalized π bond group and is a group imparting a constraint geometric shape to the metal M⁴ active site. Each X³ may be the same or different and is a hydrogen atom, a halogen atom, a hydrocarbon group having 20 or less carbon atoms, a silyl group having 20 or less silicon atoms or a germyl group having 20 or less germanium atoms.

Of such compounds, a compound represented by the following formula (8) is preferable.

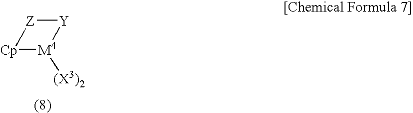

In the formula (8), M⁴ is titanium, zirconium, or hafnium. X³ is the same as that described in the formula (7). Cp is π-bonded to M⁴ and is a substituted cyclopentadienyl group having a substituent Z. Z is oxygen, sulfur, boron, or an element of Group 4 of the periodic table (e.g., silicon, germanium, or tin). Y is a ligand having nitrogen, phosphorus, oxygen or sulfur, and Z and Y may together form a condensed ring. Specific examples of the metallocene compounds represented by the formula (8) include:

(dimethyl(t-butylamide)(tetramethyl-η⁵-cyclopentadien yl)silane)titanium dichloride, ((t-butylamide)(tetramethyl-η⁵-cyclopentadienyl)-1,2-ethane diyl)titanium dichloride, and the like. Also employable are metallocene compounds wherein titanium is replaced with zirconium or hafnium in the above compounds.

Example 7 of Metallocene Compound:

As the metallocene compound, a metallocene compound represented by the following formula (9) is also employable.

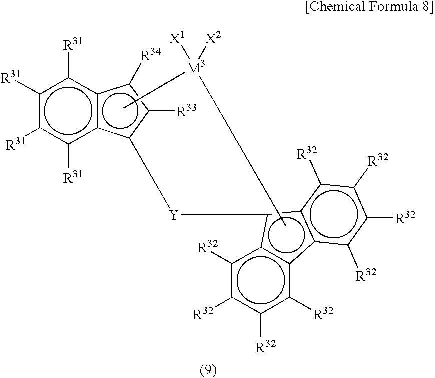

In the formula (9), M³is a transition metal atom of Group 4 of the periodic table, specifically titanium, zirconium, or hafnium, preferably zirconium. Each R³¹ may be the same or different, and at least one of them is an aryl group having 11 to 20 carbon atom(s), an arylalkyl group having 12 to 40 carbon atoms, an arylalkenyl group having 13 to 40 carbon atoms, an alkylaryl group having 12 to 40 carbon atoms, or a silicon-containing group; or at least two neighboring groups of the groups indicated by R³¹ form single or plural aromatic rings or aliphatic rings together with carbon atoms to which they are bonded. In this case, the ring formed by R³¹ has 4 to 20 carbon atoms in all including carbon atoms to which R³¹ is bonded. R³¹ other than R³¹ that is an aryl group, an arylalkyl group, an arylalkenyl group, or an alkylaryl group or that forms an aromatic ring or an aliphatic ring is a hydrogen atom, a halogen atom, an alkyl group having 1 to 10 carbon atom(s) or a silicon-containing group. Each R³² may be the same or different and is a hydrogen atom, a halogen atom, an alkyl group having 1 to 10 carbon atom(s), an aryl group having 6 to 20 carbon atoms, an alkenyl group having 2 to 10 carbon atoms, an arylalkyl group having 7 to 40 carbon atoms, an arylalkenyl group having 8 to 40 carbon atoms, an alkylaryl group having 7 to 40 carbon atoms, a silicon-containing group, an oxygen-containing group, a sulfur-containing group, a nitrogen-containing group, or a phosphorus-containing group. At least two neighboring groups of the groups indicated by R³² may form single or plural aromatic rings or aliphatic rings together with carbon atoms to which they are bonded. In this case, the ring formed by R³² has 4 to 20 carbon atoms in all including carbon atoms to which R³² is bonded. R³² other than R³² that forms an aromatic ring or an aliphatic ring is a hydrogen atom, a halogen atom, an alkyl group having 1 to 10 carbon atom(s), or a silicon-containing group. In the groups constituted of single or plural aromatic rings or aliphatic rings formed by two groups indicated by R³², an embodiment wherein the fluorenyl group part has such a structure as represented by the following formula is included.

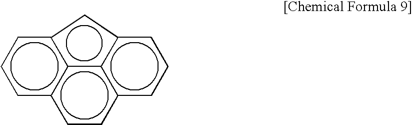

R³² is preferably a hydrogen atom or an alkyl group, particularly preferably a hydrogen atom or a hydrocarbon group having 1 to 3 carbon atom(s), i.e., methyl, ethyl, or propyl. A preferred example of the fluorenyl group having R³² as such a substituent is a 2,7-dialkyl-fluorenyl group, and in this case, an alkyl group of the 2,7-dialkyl is, for example, an alkyl group having 1 to 5 carbon atom(s). R³¹ and R³² may be the same as or different from each other. R³³ and R³⁴ may be the same as or different from each other and are each a hydrogen atom, a halogen atom, an alkyl group having 1 to 10 carbon atom(s), an aryl group having 6 to 20 carbon atoms, an alkenyl group having 2 to 10 carbon atoms, an arylalkyl group having 7 to 40 carbon atoms, and arylalkenyl group having 8 to 40 carbon atoms, an alkylaryl group having 7 to 40 carbon atoms, a silicon-containing group, an oxygen-containing group, a sulfur-containing group, a nitrogen-containing group, or a phosphorus-containing group, similarly to the above. At least one of R³³ and R³⁴ is preferably an alkyl group having 1 to 3 carbon atom(s). X¹ and X² may be the same as or different from each other and are each a hydrogen atom, a halogen atom, a hydrocarbon group having 1 to 20 carbon atom(s), a halogenated hydrocarbon group having 1 to 20 carbon atom(s), an oxygen-containing group, a sulfur-containing group or a nitrogen-containing group, or X¹ and X² form a conjugated diene residue. Preferred examples of the conjugated diene residues formed from X¹ and X² include residues of 1,3-butadiene, 2,4-hexadiene, 1-phenyl-1,3-pentadiene and 1,4-diphenylbutadiene, and these residues may be further substituted with a hydrocarbon group having 1 to 10 carbon atom(s). X¹ and X² are each preferably a halogen atom, a hydrocarbon group having 1 to 20 carbon atom(s) or a sulfur-containing group. Y is a divalent hydrocarbon group having 1 to 20 carbon atom(s), a divalent halogenated hydrocarbon group having 1 to 20 carbon atom(s), a divalent silicon-containing group, a divalent germanium-containing group, a divalent tin-containing group, —O—, —CO—, —S—, —SO—, —SO₂—, —NR³⁵—, —P(R³⁵)—, —P(O)(R³⁵)—, —BR³⁵— or —AlR³⁵— (R³⁵ is a hydrogen atom, a halogen atom, a hydrocarbon group having 1 to 20 carbon atom(s) or a halogenated hydrocarbon group having 1 to 20 carbon atom(s)). Of these divalent groups, preferable are those wherein the shortest linkage part of —Y— is constituted of one or two atoms. R³⁵ is a halogen atom, a hydrocarbon group having 1 to 20 carbon atom(s) or a halogenated hydrocarbon group having 1 to 20 carbon atom(s). Y is preferably a divalent hydrocarbon group having 1 to 5 carbon atom(s), a divalent silicon-containing group or a divalent germanium-containing group, more preferably a divalent silicon-containing group, particularly preferably alkylsilylene, alkylarylsilylene or arylsilylene.

Example 8 of Metallocene Compound:

As the metallocene compound, a metallocene compound represented by the following formula (10) is also employable.

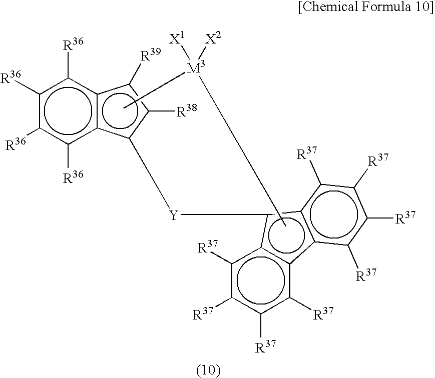

In the formula (10), M³is a transition metal atom of Group 4 of the periodic table, specifically titanium, zirconium or hafnium, preferably zirconium. Each R³⁶ may be the same or different and is a hydrogen atom, a halogen atom, an alkyl group having 1 to 10 carbon atom(s), an aryl group having 6 to 10 carbon atoms, an alkenyl group having 2 to 10 carbon atoms, a silicon-containing group, an oxygen-containing group, a sulfur-containing group, a nitrogen-containing group or a phosphorus-containing group. The alkyl group and the alkenyl group may be substituted with a halogen atom. R³⁶ is preferably an alkyl group, an aryl group or a hydrogen atom, particularly preferably a hydrocarbon group having 1 to 3 carbon atom(s), i.e., methyl, ethyl, n-propyl or i-propyl, an aryl group, such as phenyl, α-naphthyl or β-naphthyl, or a hydrogen atom. Each R³⁷ may be the same or different and is a hydrogen atom, a halogen atom, an alkyl group having 1 to 10 carbon atom(s), an aryl group having 6 to 20 carbon atoms, an alkenyl group having 2 to 10 carbon atoms, an arylalkyl group having 7 to 40 carbon atoms, an arylalkenyl group having 8 to 40 carbon atoms, an alkylaryl group having 7 to 40 carbon atoms, a silicon-containing group, an oxygen-containing group, a sulfur-containing group, a nitrogen-containing group or a phosphorus-containing group. The alkyl group, the aryl group, the alkenyl group, the arylalkyl group, the arylalkenyl group and the alkylaryl group may be substituted with halogen. Of these, R³⁷ is preferably a hydrogen atom or an alkyl group, particularly preferably a hydrogen atom or a hydrocarbon group having 1 to 4 carbon atom(s), i.e., methyl, ethyl, n-propyl, i-propyl, n-butylortert-butyl. R³⁶and R³⁷ may be the same as or different from each other. One of R³⁸ and R³⁹ is an alkyl group having 1 to 5 carbon atom(s), and the other is a hydrogen atom, a halogen atom, an alkyl group having 1 to 10 carbon atom(s), an alkenyl group having 2 to 10 carbon atoms, a silicon-containing group, an oxygen-containing group, a sulfur-containing group, a nitrogen-containing group or a phosphorus-containing group. It is preferable that one of R³⁸ and R³⁹ is an alkyl group having 1 to 3 carbon atom(s), such as methyl, ethyl or propyl, and the other is a hydrogen atom. X¹ and X² may be the same as or different from each other and are each a hydrogen atom, a halogen atom, a hydrocarbon group having 1 to 20 carbon atom(s), a halogenated hydrocarbon group having 1 to 20 carbon atom(s), an oxygen-containing group, a sulfur-containing group or a nitrogen-containing group, or X¹ and X² form a conjugated diene residue. X¹ and X² are each preferably a halogen atom or a hydrocarbon group having 1 to 20 carbon atom(s). Y is a divalent hydrocarbon group having 1 to 20 carbon atom(s), a divalent halogenated hydrocarbon group having 1 to 20 carbon atom(s), a divalent silicon-containing group, a divalent germanium-containing group, a divalent tin-containing group, —O—, —CO—, —S—, —SO—, —SO₂—, —NR⁴⁰—, —P(R⁴⁰)—, —P(O)(R⁴⁰)—, —BR⁴⁰— or —AlR⁴⁰— (R⁴⁰ is a hydrogen atom, a halogen atom, a hydrocarbon group having 1 to 20 carbon atom(s) or a halogenated hydrocarbon group having 1 to 20 carbon atom(s)). Y is preferably a divalent hydrocarbon group having 1 to 5 carbon atom(s), a divalent silicon-containing group or a divalent germanium-containing group, more preferably a divalent silicon-containing group, particularly preferably alkylsilylene, alkylarylsilylene or arylsilylene.

Example 9 of Metallocene Compound:

As the metallocene compound, a metallocene compound represented by the following formula (11) is also employable.

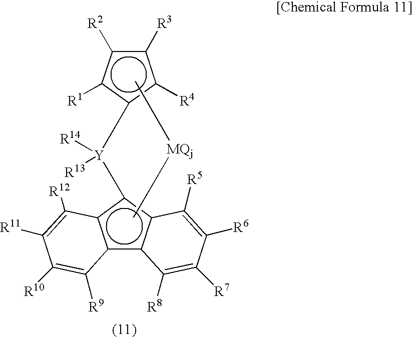

In the formula (11), Y is selected from carbon, silicon, germanium and tin atoms, M is Ti, Zr or Hf, R¹, R², R³, R⁴, R⁵, R⁶, R⁷, R⁸, R⁹, R¹⁰, R¹¹ and R¹² may be the same as or different from each other, and selected from hydrogen, a hydrocarbon group, and a silicon containing group, the adjacent substituents of R⁵ to R¹² may be bonded to each other to form a ring, R¹³ and R¹⁴ may be the same as or different from each other, and selected from a hydrocarbon group, and a silicon containing group, and R¹³ and R¹⁴ may be bonded to each other to form a ring. Q may be selected in the same or different combination from halogen, a hydrocarbon group, an anionic ligand, and a neutral ligand which can be coordinated by a lone pair of electrons, and j is an integer of 1 to 4.

Hereinbelow, the cyclopentadienyl group, the fluorenyl group, and the bridged part which are the characteristics in the chemical structure of the metallocene compound used in the present invention, and other characteristics are sequentially explained, and then preferred metallocene compounds having both these characteristics are also explained.

Cyclopentadienyl Group

The cyclopentadienyl group may be substituted or unsubstituted. The phrase “substituted or unsubstituted cyclopentadienyl group” means a cyclopentadienyl group in which R¹, R², R³, and R⁴ of the cyclopentadienyl skeleton in the formula (11) are all hydrogen atoms, or at least one of R¹, R², R³, and R⁴ is a hydrocarbon group (f1), preferably a hydrocarbon group (f1′) having a total of 1 to 20 carbon atom(s), or a silicon-containing group (f2), preferably a silicon-containing group (f2′) having a total of 1 to 20 carbon atom(s). If at least two of R¹, R², R³, and R⁴ are substituted, the substituents maybe the same as or different from each other. Further, the phrase “hydrocarbon group having a total of 1 to 20 carbon atom(s)” means an alkyl group, an alkenyl group, an alkynyl group, or an aryl group, which is composed of only carbon and hydrogen. It includes one in which both of any two adjacent hydrogen atoms are substituted to form an alicyclic or aromatic ring. Examples of the hydrocarbon group (f1′) having a total of 1 to 20 carbon atom(s) includes, in addition to an alkyl group, an alkenyl group, an alkynyl group, or an aryl group, which is composed of only carbon and hydrogen, a heteroatom-containing hydrocarbon group which is a hydrocarbon group in which a part of the hydrogen atoms directly bonded to carbon atoms are substituted with a halogen atom, an oxygen-containing group, a nitrogen-containing group, or a silicon-containing group, and an alicyclic group in which any two hydrogen atoms which are adjacent to each other are substituted. Examples of the hydrocarbon group (f1′) include:

a linear hydrocarbon group such as a methyl group, an ethyl group, an n-propyl group, an allyl group, an n-butyl group, an n-pentyl group, an n-hexyl group, an n-heptyl group, an n-octyl group, an n-nonyl group, and an n-decanyl group;

a branched hydrocarbon group such as an isopropyl group, a t-butyl group, an amyl group, a 3-methylpentyl group, a 1,1-diethylpropyl group, a 1,1-dimethylbutyl group, a 1-methyl-1-propyl butyl group, a 1,1-propyl butyl group, a 1,1-dimethyl-2-methylpropyl group, and a 1-methyl-1-isopropyl-2-methylpropyl group;

a cycloalkane group such as a cyclopentyl group, a cyclohexyl group, a cycloheptyl group, a cyclooctyl group, a norbornyl group, and an adamanthyl group;

a cyclic unsaturated hydrocarbon group and a nuclear alkyl-substituted product thereof such as a phenyl group, a naphthyl group, a biphenyl group, a phenanthryl group, and an anthracenyl group;

a saturated hydrocarbons group substituted with an aryl group such as benzyl group and a cumyl group;

a heteroatom-containing hydrocarbon group such as a methoxy group, an ethoxy group, a phenoxy group, an N-methylamino group, a trifluoromethyl group, a tribromomethyl group, a pentafluoroethyl group, and a pentafluorophenyl group.

The phrase “silicon-containing group (f2)” means a group in which ring carbons of the cyclopentadienyl group are directly covalently bonded to silicon, and specific examples thereof include an alkyl silyl group and an aryl silyl group. Examples of the silicon-containing group (f2′) having a total of 1 to 20 carbon atom(s) include a trimethylsilyl group, and a triphenylsilyl group.

Fluorenyl Group

The fluorenyl group may be substituted or unsubstituted. The phrase “substituted or unsubstituted fluorenyl group” means a fluorenyl group in which R⁵, R⁶, R⁷, R⁸, R⁹, R¹⁰, R¹¹ and R¹² of the fluorenyl skeleton in the formula (11) are all hydrogen atoms, or at least one of R⁵, R⁶, R⁷, R⁸, R⁹, R¹⁰, R¹¹, and R¹² is a hydrocarbon group (f1), preferably a hydrocarbon group (f1′) having a total of 1 to 20 carbon atom(s), or a silicon-containing group (f2), preferably a silicon-containing group (f2′) having a total of 1 to 20 carbon atom(s). If at least two of R⁵, R⁶, R⁷, R⁸, R⁹, R¹⁰, R¹¹, and R¹² are substituted, the substituents may be the same as or different from each other. R⁵, R⁶, R⁷, R⁸ R⁹, R¹⁰, R¹¹, and R¹² may be bonded to each other to form a ring. From a viewpoint of easy preparation of a catalyst, R⁶ and R¹¹, and R⁷ and R¹⁰ are preferably the same to each other.

A preferable example of the hydrocarbon group (f1) is a hydrocarbon group (f1′) having a total of 1 to 20 carbon atom(s), and a preferable example of the silicon-containing group (f2) is a silicon-containing group (f2′) having a total of 1 to 20 carbon atom(s).

Covelnt Bond Bridging

The main chain of the bond which binds the cyclopentadienyl group with the fluorenyl group is a divalent covalent bond bridging containing a carbon atom, a silicon atom, a germanium atom and a tin atom. An important point when carrying out a high temperature solution polymerization is that a bridging atom Y of the covalent bond bridging part has R¹³ and R¹⁴ which may be the same as or different from each other. A preferable example of the hydrocarbon group (f1) is a hydrocarbon group (f1′) having a total of 1 to 20 carbon atom(s), and a preferable example of the silicon-containing group (f2) is a silicon-containing group (f2′) having a total of 1 to 20 carbon atom(s).

Other Characteristics of Bridged Metallocene Compound

As for other characteristics of the bridged metallocene compound, in the above-described formula (11), Q is selected in the same or different combination from halogen, a hydrocarbon group having 1 to 10 carbon atom(s), a neutral, conjugated or non-conjugated diene having 10 carbon atoms or less, an anionic ligand, and a neutral ligand which can be coordinated by a lone pair of electrons. Specific examples of halogen include fluorine, chlorine, bromine, and iodine, and specific examples of the hydrocarbon group include methyl, ethyl, n-propyl, isopropyl, 2-methylpropyl, 1,1-dimethylpropyl, 2,2-dimethylpropyl, 1,1-diethylpropyl, 1-ethyl-1-methylpropyl, 1,1,2,2-tetramethylpropyl, sec-butyl, tert-butyl, 1,1-dimethylbutyl, 1,1,3-trimethylbutyl, neopentyl, cyclohexylmethyl, and cyclohexyl, 1-methyl-1-cyclohexyl. Specific examples of the neutral, conjugated or non-conjugated diene having 10 carbon atoms or less include s-cis- or s-trans-η⁴-1,3-butadiene, s-cis- or s-trans-η⁴-1,4-diphenyl-1,3-butadiene, s-cis- or s-trans-η⁴-3-methyl-1,3-pentadiene, s-cis- or s-trans-η⁴-1,4-dibenzyl-1,3-butadiene, s-cis- or s-trans-η⁴-2,4-hexadiene, s-cis- or s-trans-η4-1,3-pentadiene, s-cis- or s-trans-η⁴-1,4-ditolyl-1,3-butadiene, and s-cis- or s-trans-η⁴-1,4-bis(trimethylsilyl)-1,3-butadiene. Specific examples of the anionic ligand include an alkoxy group such as methoxy, tert-butoxy, and phenoxy, a carboxylate group such as acetate, and benzoate, and a sulfonate group such as mesylate, and tosylate. Specific examples of the neutral ligand which can be coordinated by a lone pair of electrons include organophosphorus compounds such as trimethylphosphine, triethylphosphine, triphenylphosphine, and diphenylmethyl phosphine, or ethers such as tetrahydrofuran, diethyl ether, dioxane, and 1,2-dimethoxyethane. j is an integer of 1 to 4, and when j is no less than 2, Q's may be the same as or different from each other.

Example 10 of Metallocene Compound:

As the metallocene compound, a metallocene compound represented by the following formula (12) is also employable.

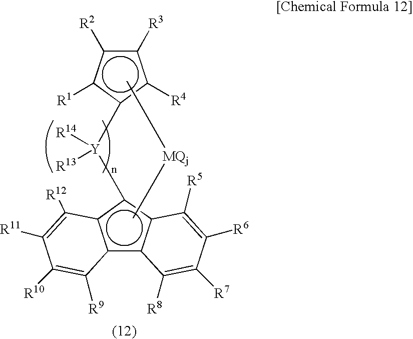

In the above formula, R¹, R², R³, R⁴, R⁵, R⁶, R⁷, R⁸, R⁹, R¹⁰, R¹¹, R¹², R¹³, and R¹⁴ may be the same as or different from each other, and selected from hydrogen, a hydrocarbon group, and a silicon containing group, the adjacent substituents of R¹ to R¹⁴ may be bonded to each other to form a ring, M is Ti, Zr or Hf, Y is an atom of Group 14 of the periodic table, Q is selected in the same or different combination from halogen, a hydrocarbon group, a neutral, conjugated or non-conjugated diene having 10 carbon atoms or less, an anionic ligand, and a neutral ligand which can be coordinated by a lone pair of electrons, n is an integer of 2 to 4, and j is an integer of 1 to 4.

In the formula (12), the hydrocarbon group is preferably an alkyl group having 1 to 20 carbon atom(s), an arylalkyl group having 7 to 20 carbon atoms, an aryl group having 6 to 20 carbon atoms, or an alkylaryl group having 7 to 20 carbon atoms, and may contain at least one ring structure.

Specific examples thereof include methyl, ethyl, n-propyl, isopropyl, 2-methylpropyl, 1,1-dimethylpropyl, 2,2-dimethylpropyl, 1,1-diethylpropyl, 1-ethyl-1-methylpropyl, 1,1,2,2-tetramethylpropyl, sec-butyl, tert-butyl, 1,1-dimethylbutyl, 1,1,3-trimethyl butyl, neopentyl, cyclohexylmethyl, cyclohexyl, 1-methyl-1-cyclohexyl, 1-adamanthyl, 2-adamanthyl, 2-methyl-2-adamanthyl, menthyl, norbornyl, benzyl, 2-phenylethyl, 1-tetrahydro naphthyl, 1-methyl-1-tetrahydro naphthyl, phenyl, naphthyl, and tolyl.

In the formula (12), the silicon-containing group is preferably an alkyl or arylsilyl group having 1 to 4 silicon atom(s) and 3 to 20 carbon atoms, and specific examples thereof include trimethylsilyl, tert-butyldimethylsilyl, and triphenylsilyl.

In the present invention, R¹ to R¹⁴ in the formula (12) are selected from hydrogen, a hydrocarbon group, and a silicon-containing hydrocarbon group, and may be the same as or different from each other. Preferable examples of the hydrocarbon group and the silicon-containing group are as described above.

The adjacent substituents of R¹ to R¹⁴ in the cyclopentadienyl ring in the formula (12) may be bonded to each other to form a ring.

M of the formula (12) is an element of Group 4 of the periodic table, that is, zirconium, titanium or hafnium, preferably zirconium.

Y is an atom of Group 14 of the periodic table, preferably a carbon atom or a silicon atom. n is an integer of 2 to 4, preferably 2 to 3, and particularly preferably 2.

Q is selected in the same or different combination from halogen, a hydrocarbon group, a neutral, conjugated or non-conjugated diene having 10 carbon atoms or less, an anionic ligand, and a neutral ligand which can be coordinated by a lone pair of electrons. If Q is a hydrocarbon group, it is more preferably a hydrocarbon group having 1 to 10 carbon atom(s).

Specific examples of halogen include fluorine, chlorine, bromine, and iodine, and specific examples of the hydrocarbon group,include methyl, ethyl, n-propyl, isopropyl, 2-methylpropyl, 1,1-dimethylpropyl, 2,2-dimethylpropyl, 1,1-diethylpropyl, 1-ethyl-1-methylpropyl, 1,1,2,2-tetramethylpropyl, sec-butyl, tert-butyl, 1,1-dimethylbutyl, 1,1,3-trimethylbutyl, neopentyl, cyclohexylmethyl, and cyclohexyl, 1-methyl-1-cyclohexyl. Specific examples of the neutral, conjugated or non-conjugated diene having 10 carbon atoms or less include s-cis- or s-trans-η⁴-1,3-butadiene, s-cis- or s-trans-η⁴-1,4-diphenyl-1,3-butadiene, s-cis- or s-trans-η⁴-3-methyl-1,3-pentadiene, s-cis- or s-trans-η⁴-1,4-dibenzyl-1,3-butadiene, s-cis- or s-trans-η⁴-2,4-hexadiene, s-cis- or s-trans-η⁴-1,3-pentadiene, s-cis- or s-trans-η⁴-1,4-ditolyl-1,3-butadiene, and s-cis- or s-trans-η⁴-1,4-bis(trimethylsilyl)-1,3-butadiene. Specific examples of the anionic ligand include an alkoxy group such as methoxy, tert-butoxy, and phenoxy, a carboxylate group such as acetate, and benzoate, and a sulfonate group such as mesylate, and tosylate. Specific examples of the neutral ligand which can be coordinated by a lone pair of electrons include organophosphorus compounds such as trimethylphosphine, triethylphosphine, triphenylphosphine, and diphenylmethyl phosphine, or ethers such as tetrahydrofuran, diethyl ether, dioxane, and 1,2-dimethoxyethane. When j is no less than 2, Q's may be the same as or different from each other.

In the formula (12), 2 to 4 Y's are present, and Y's may be the same as or different from each other. A plurality of R¹³'s and a plurality of R¹⁴'s, which are each bonded to Y, may be the same as or different from each other. For example, a plurality of R¹³'s which are bonded to the same Y may be different from each other, and a plurality of R¹³'s which are bonded to the different Y's may be the same to each other. Otherwise, R¹³'s and R¹⁴'s may be taken to form a ring.

Preferable examples of the compound represented by the formula (12) include a Group 4 transition metal compound represented by the following formula (13).

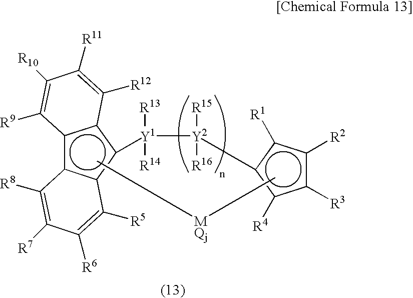

In the formula (13), R¹, R², R³, R⁴, R⁵, R⁶, R⁷, R⁸, R⁹, R¹⁰, R¹¹, and R¹² may be the same as or different from each other, and selected from hydrogen, a hydrocarbon group, and a silicon containing group, R¹³, R¹⁴, R¹⁵, and R¹⁶ are hydrogen, or a hydrocarbon group, and n is an integer of 1 to 3. With n=1, R¹ to R¹⁶ are not hydrogen at the same time, and each may be the same as or different from each other. The adjacent substituents of R⁵ to R¹² may be bonded to each other to form a ring, R¹³ and R¹⁵ may be bonded to each other to form a ring, and R¹³ and R¹⁵, and R¹⁴ and R¹⁶ may be bonded to each other to form a ring at the same time, Y¹ and Y², which may be the same as or different from each other, are atoms of Group 14 of the periodic table, M is Ti, Zr or Hf, Q is selected in the same or different combination from halogen, a hydrocarbon group, an anionic ligand, and a neutral ligand which can be coordinated by a lone pair of electrons, and j is an integer of 1 to 4.

The compounds such as those as described in (Example 9 of Metallocene Compound) and (Example 10 of Metallocene Compound) are mentioned in JP-A No. 2004-175707, WO2001/027124, WO2004/029062, and WO2004/083265.

The metallocene compounds described above are used singly or in combination of two or more kinds. The metallocene compounds may be used after diluted with hydrocarbon, halogenated hydrocarbon or the like.

The catalyst component comprises a bridged metallocene compound represented as (A) above and at least one compound (B) selected from (b-1) an organoaluminum oxy-compound, (b-2) a compound which reacts with the bridged metallocene compound (A) to form an ion pair, and (b-3) an organoaluminum compound.

Hereinbelow, the component (B) will be described specifically.

(b-1) Organoaluminum Oxy-Compound:

According to the present invention, as the organoaluminum oxy-compound (b-1), publicly known aluminoxane can be used as it is. Specifically, such publicly known aluminoxane is represented by the following formula (14)

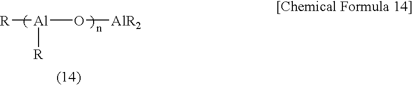

and/or (15):

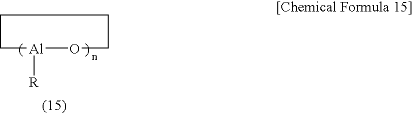

wherein R represents a hydrocarbon group having 1 to 10 carbon atom(s), and n represents an integer of 2 or more. Among these compound, the methyl aluminoxane in which R is a methyl group and n is 3 or more, preferably 10 or more are preferably used. These aluminoxanes may be incorporated with some organoaluminum compounds. In addition, when a high temperature solution polymerization is carried out, the benzene-insoluble organoaluminum oxy-compounds as described in JP-A No. 2-78687 can be employed. Further, the organoaluminumoxy-compounds as described in JP-A No.2-167305, and the aluminoxanes having at least two kinds of alkyl groups as described in JP-A Nos. 2-167305, 2-24701, and 3-103407 are preferably used. In addition, the phrase “benzene insoluble” regarding the organoaluminum oxy-compounds, the proportion of the Al components dissolved in benzene at 60° C. in terms of an Al atom is usually 10% or less, preferably 5% or less, and particularly preferably 2% or less, and that is, the compound has insolubility or poor solubility in benzene.

Examples of the organoaluminum oxy-compound (b-1) used in the present invention include a modified methyl aluminoxane having the structure of the following structure (16).

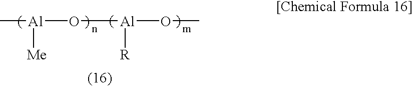

(wherein R represents a hydrocarbon group having 1 to 10 carbon atom(s), and m and n represent integers of 2 or more) This modified methyl aluminoxane is prepared from trimethyl aluminum and alkyl aluminum other than trimethyl aluminum. This modified methyl aluminoxane is generally referred to as MMAO. Such the MMAO can prepared by the method as described in U.S. Pat. Nos. 4,960,878 and 5,041,584. Further, the modified methyl aluminoxane in which R is an iso-butyl group, prepared from trimethyl aluminum and tri-isobutyl aluminum from Tosoh Finechem Corp., is commercially produced in a trade name of MMAO or TMAO. The MMAO is aluminoxane with improved solubility in various solvents, and storage stability, and specifically, it is dissolved in an aliphatic or alicyclic hydrocarbon, although the aluminoxane described for the formula (14) or (15) has insolubility or poor solubility in benzene.

Further, examples of the organoaluminum oxy-compound (b-1) used in the present invention include a boron-containing organoaluminum oxy-compound represented by the following formula (17).

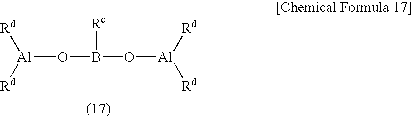

(wherein R^{c} represents a hydrocarbon group having 1 to 10 carbon atom(s), Rd is may be the same as or different from each other, and represent a hydrogen atom, a halogen atom or a hydrocarbon group having 1 to 10 carbon atom(s)).

(b-2) Compounds Which React with the bridged Metallocene Compound (A) to Form an Ion Pair:

Examples of the compound (b-2) which reacts with the bridged metallocene compound (A) to form an ion pair (referred to as an “ionic compound” hereinafter) may include Lewis acids, ionic compounds, borane compounds and carborane compounds, as described in each publication of JP-A Nos. 1-501950, 1-502036, 3-179005, 3-179006, 3-207703 and 3-207704, and U.S. Pat. No. 5,321,106. They also include a heteropoly compound and an iso-poly compound.

According to the present invention, the ionic compound which is preferably employed is a compound represented by the following formula (18).

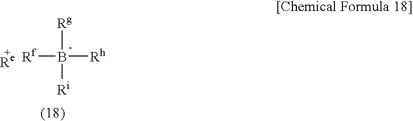

wherein examples of R^{e+} include H⁺, a carbenium cation, an oxonium cation, an ammonium cation, a phosphonium cation, a cycloheptyltrienyl cation, and a ferrocenium cation having transition metal. R^{f} to Rⁱ may be the same as or different from each other, and each represent an organic group, preferably an aryl group.

Specific examples of the carbenium cation include 3-substituted carbenium cations such as a triphenyl carbenium cation, a tris(methylphenyl) carbenium cation, and a tris(dimethylphenyl) carbenium cation.

Specific examples of the ammonium cation include a trialkyl ammonium cation such as a trimethyl ammonium cation, a triethyl ammonium cation, a tri(n-propyl)ammonium cation, a tri-isopropyl ammonium cation, a tri (n-butyl)ammonium cation, and a tri-isobutyl ammonium cation, a N,N-dialkyl anilinium cation such as an N,N-dimethyl anilinium cation, an N,N-diethyl anilinium cation, and an N,N-2,4,6-pentamethyl anilinium cation, and a dialkyl ammonium cation such as a diisopropyl ammonium cation and a dicyclohexyl ammonium cation.

Specific examples of the phosphonium cation include a triaryl phosphonium cation such as a triphenylphosphonium cation, tris(methylphenyl)phosphonium cation, and tris(dimethylphenyl)phosphonium cation.

Among them, R^{e+} is preferably a carbenium cation, an ammonium cation, or the like, and particularly preferably a triphenylcarbenium cation, a N,N-dimethyl anilinium cation, or an N,N-diethyl anilinium cation.

Specific examples of the carbenium salts include triphenyl carbenium tetraphenylborate, triphenyl carbenium tetrakis(pentafluorophenyl)borate, triphenyl carbenium tetrakis(3,5-ditrifluoromethylphenyl)borate, tris(4-methylphenyl) carbenium tetrakis(pentafluorophenyl)borate, and tris(3,5-dimethylphenyl) carbenium tetrakis(pentafluorophenyl)borate.

Examples of the ammonium salt include a trialkyl-substituted ammonium salt, an N,N-dialkyl anilinium salt, and a dialkyl ammonium salt.

Specific examples of the trialkyl-substituted ammonium salt include triethyl ammonium tetraphenyl borate, tripropyl ammonium tetraphenyl borate, tri (n-butyl) ammonium tetraphenyl borate, trimethyl ammoniumtetrakis(p-tolyl)borate, trimethyl ammonium tetrakis(o-tolyl)borate, tri(n-butyl)ammonium tetrakis(pentafluorophenyl)borate, triethyl ammonium tetrakis(pentafluorophenyl)borate, tripropyl ammonium tetrakis(pentafluorophenyl)borate, tripropyl ammonium tetrakis(2,4-dimethylphenyl)borate, tri(n-butyl)ammonium tetrakis(3,5-dimethylphenyl)borate, tri(n-butyl)ammonium tetrakis(4-trifluoromethylphenyl)borate, tri(n-butyl)ammonium tetrakis(3,5-ditrifluoromethylphenyl)borate, tri(n-butyl)ammonium tetrakis(o-tolyl)borate, dioctadecyl methyl ammonium tetraphenyl borate, dioctadecyl methyl ammonium tetrakis (p-tolyl)borate, dioctadecyl methyl ammonium tetrakis(o-tolyl)borate, dioctadecyl methyl ammonium tetrakis(pentafluorophenyl)borate, dioctadecyl methyl ammonium tetrakis(2,4-dimethylphenyl)borate, dioctadecyl methyl ammonium tetrakis(3,5-dimethylphenyl)borate, dioctadecyl methyl ammonium tetrakis(4-trifluoromethylphenyl)borate, dioctadecyl methyl ammonium tetrakis(3,5-ditrifluoromethylphenyl)borate, and dioctadecyl methyl ammonium.

Specific examples of the N,N-dialkyl anilinium salt, include N,N-dimethyl anilinium tetraphenyl borate, N,N-dimethyl anilinium tetrakis(pentafluorophenyl)borate, N,N-dimethyl anilinium tetrakis(3,5-ditrifluoromethylphenyl)borate, N,N-diethyl anilinium tetraphenyl borate, N,N-diethyl anilinium tetrakis(pentafluorophenyl)borate, N,N-diethyl anilinium tetrakis(3,5-ditrifluoromethylphenyl)borate, N,N-2,4,6-pentamethyl anilinium tetraphenyl borate, and N,N-2,4,6-pentamethyl anilinium tetrakis(pentafluorophenyl)borate.

Specific examples of the dialkyl ammonium salt include di(1-propyl)ammonium tetrakis(pentafluorophenyl)borate, and dicyclohexyl ammonium tetraphenyl borate.

The ionic compounds as disclosed in JP-A No. 2004-51676 by the present Applicant can be used without any restriction.

The ionic compounds (b-2) can be used in a mixture of two or more kinds.

(b-3) Organoaluminum Compound:

Examples of the organoaluminum compound (b-3) which constitutes the catalyst for olefin polymerization include an organoaluminum compound represented by the following formula (X), and an alkylated complex with a metal element from Group 1 of the periodic table and aluminum, which is represented by the following formula (19):
R^{a}ₘAl(OR^{b})ₙHₚX_{q} (19)

In the formula, R^{a} and R^{b} are may be the same as or different from each other and each represent a hydrocarbon group having usually 1 to 15 carbon atom(s), preferably 1 to 4 carbon atom(s), X is a halogen atom, and m, n, p, and q are numbers satisfying the conditions: 0<m≦3, 0≦n<3, 0≦p<3, and 0≦q<3, while m+n+p+q=3. Specific examples of the compound represented by the formula (19) include tri-n-alkyl aluminum such as trimethyl aluminum, triethyl aluminum, tri-n-butyl aluminum, trihexyl aluminum, and trioctyl aluminum; tri-branch chained alkyl aluminum such as tri-isopropyl aluminum, tri-isobutyl aluminum, tri-sec-butyl aluminum, tri-tert-butyl aluminum, tri-2-methylbutyl aluminum, tri-3-methyl hexyl aluminum, and tri-2-ethylhexyl aluminum; tri-cycloalkyl aluminum such as tri-cyclohexyl aluminum, and tri-cyclooctyl aluminum; triaryl aluminum such as triphenyl aluminum, and tritolyl aluminum; dialkyl aluminum hydride such as diisopropyl aluminum hydride, and diisobutyl aluminum hydride; alkenyl aluminum, such as isoprenyl aluminum, represented by the formula: (i-C₄H₉)ₓAl_{y}(C₅H₁₀)_{z}, wherein x, y and z are positive integers, and z is the numbers satisfying the conditions: z≦2x; alkyl aluminum alkoxide such as isobutyl aluminum methoxide, and isobutyl aluminum ethoxide; dialkyl aluminum alkoxide such as dimethyl aluminum methoxide, diethyl aluminum ethoxide, and dibutyl aluminum butoxide; alkyl aluminum sesquialkoxide such as ethyl aluminum sesquiethoxide, and butyl aluminum sesquibutoxide; partially alkoxylated alkyl aluminum, for example, having a mean compositions represented by the general formula R^{a}_{2.5}Al(OR^{b})_{0.5}; alkyl aluminum aryloxide such as diethyl aluminum phenoxide and diethyl aluminum (2,6-di-t-butyl-4-methylphenoxide); dialkyl aluminum halide such as dimethyl aluminum chloride, diethyl aluminum chloride, dibutyl aluminum chloride, diethyl aluminum bromide, and diisobutyl aluminum chloride; alkyl aluminum sesquihalide such as ethyl aluminum sesquichloride, butyl aluminum sesquichloride, and ethyl aluminum sesquibromide; partially halogenated alkyl aluminum of alkyl aluminum dihalide such as ethyl aluminum dichloride; dialkyl aluminum hydride such as diethyl aluminum hydride, and dibutyl aluminum hydride; other partially hydrogenated alkyl aluminum, for example, alkyl aluminum dihydrides such as ethyl aluminum dihydride and propyl aluminum dihydride; and partially alkoxylated and halogenated alkyl aluminums such as ethyl aluminum ethoxychloride, butyl aluminum butoxychloride and ethyl aluminum ethoxybromide.

Examples of an alkylated complex with a metal element from Group 1 of the periodic table and aluminum, represented by the following formula (20):
M²AlR^{a}₄ (20)

(wherein M² is Li, Na or K, and R^{a} is a hydrocarbon group having usually 1 to 15 carbon atom(s), preferably 1 to 4 carbon atom(s)) include LiAl(C₂H₅)₄, LiAl(C₇H₁₅)₄, and the like.

The compounds similar to the compounds represented by the formula (20), for example, the organoaluminum compounds in which two or more aluminum compounds are bonded via a nitrogen atom, can be used. Specific examples thereof include (C₂H₅)₂AlN(C₂H₅)Al(C₂H₅)₂.

From the viewpoint of easy availability, as an organoaluminum compound (b-3), trimethyl aluminum or tri-isobutyl aluminum is preferably used.

Polymerization:

The polyethylene wax used in the invention is obtained generally by homopolymerizing ethylene in a liquid phase or homopolymerizing or copolymerizing ethylene and an α-olefin usually in a liquid phase, in the presence of the above-mentioned metallocene catalyst. In the polymerization, the method for using each of the components, and the sequence of addition are arbitrarily selected, but the following methods may be mentioned.

[q1] A method for adding a component (A) alone to a polymerization reactor.

[q2] A method for adding a component (A) and a component (B) to a polymerization reactor in any order.

For the [q2] method, at least two of each catalyst components may be in contact with each other beforehand. At this time, a hydrocarbon solvent is generally used, but an α-olefin may be used as a solvent. The monomers used herein are as previously described.

As the polymerization process, suspension polymerization wherein polymerization is carried out in such a state that the polyethylene wax is present as particles in a solvent such as hexane, or gas phase polymerization wherein a solvent is not used, or solution polymerization wherein polymerization may be carried out at a polymerization temperature of not lower than 140° C. in such a state that the polyethylene wax is molten in the presence of a solvent or is molten alone is employable. Among these, solution polymerization is preferable in both aspects of economy and quality.

The polymerization reaction may be carried out by a batch process or a continuous process. When the polymerization is carried out by a batch process, the afore-mentioned catalyst components are used in the concentrations described below.

In the case of polymerizing an olefin using the above-described catalyst for polymerization of an olefin, the component (A) is used in the amount of usually 10⁻⁹ to 10⁻¹ mmol/liter, preferably 10⁻⁸ to 10⁻² mmol/liter.

The component (b-1) is used in the amount of usually 0.01 to 5,000, preferably 0.05 to 2,000, as a mole ratio of the component (b-1) to the all transition metal atoms (M) in the component (A) [(b-1)/M]. The component (b-2) is used in the amount of usually 0.01 to 5,000, preferably 1 to 2,000, as a mole ratio of the ionic compounds in the components (b-2) to all transition metals (M) in the component of (A) [(b-2)/M]. The component (b-3) is used in the amount of usually 1 to 10000, preferably 1 to 5000, as a mole ratio of the component (b-3) to the transition metal atoms (M) in the component (A) [(b-3)/M].

The polymerization reaction is carried out using 10 g of wax set on the filter, under the conditions of a temperature of usually −20 to +200° C., preferably 50 to 180° C., more preferably 70 to 180° C., and a pressure of usually greater than 0 and not greater than 7.8 MPa (80 kgf/cm², gauge pressure), preferably greater than 0 and not greater than 4.9 MPa (50 kgf/cm², gauge pressure).

In the polymerization, the amounts of ethylene and an optional α-olefin fed into the polymerization system are selected to obtain the wax having the specified composition above mentioned. At this time, further, a molecular weight modifier such as hydrogen can be added.

When polymerization is carried out in this manner, a polymer produced is usually obtained as a polymerization solution containing the polymer. Therefore, by the conventional treatment of the polymerization solution , a polyethylene wax is obtained.

As the metallocene catalyst, a catalyst containing the metallocene compound described in “Example 6 of metallocene compound” is preferable.

Using these catalysts, a polyolefin wax (B) having the above ranges of Mn, Mw/Mn, a melting point and other preferable physical properties can be obtained. The polyolefin wax (B) obtained with the catalysts has high effect for improving the fluidity, greatly improves the molding rate, and reduces the content of the tacky components, and thus a molded product with no surface tackiness can be obtained.

In the invention, it is particularly preferable to use a catalyst comprising a metallocene compound described in “Example 1 of metallocene compound” to produce particularly a polyethylene wax having the properties as instructed in the present application among the polyolefin wax (B).

With the use of such catalyst, a polyethylene wax having the above described properties can be readily obtained.

The form of polyethylene wax of the invention is not particularly limited, but is generally in a powder form, a pellet form, or a tablet form.

Other Additives:

In the present invention, if needed, the raw materials may contain stabilizers such as an antioxidant, an ultraviolet absorber, and a light stabilizer, and additives such as a metallic soap, a filler, and a flame retardant can be added, in addition to the thermoplastic resin (A) and the polyolefin wax (B).

Examples of the stabilizer include an antioxidant such as hindered phenol compounds, phosphite compounds, and thioether compounds;

a UV absorber such as benzotriazole compounds, and benzophenone compound; and

a light stabilizer such as hindered amine compounds.

Examples of the metallic soap include stearates such as magnesium stearate, calcium stearate, barium stearate, and zinc stearate.

Examples of the filler include calcium carbonate, titanium oxide, barium sulfate, talc, clay and carbon black.

Examples of the flame retardant include halogenated diphenyl ether such as decabromodiphenyl ether and octabromodiphenyl, and a halogen compound such as halogenated polycarbonate;

inorganic compounds such as antimony trioxide, antimony tetraoxide, antimony pentoxide, sodium pyroantimonate, and aluminum hydroxide; and

phosphorus compounds.

Further, as the flame retarding aid for drip prevention, a compound such as tetrafluoroethylene can be added.

Examples of the antibacterial agent or the antifungal agent include organic compounds such as an imidazole compound, thiazole compound, a nitrile compound, a haloalkyl compound, and a pyridine compound;

inorganic substances such as silver, a silver compound, a zinc compound, a copper compound, and a titanium compound; and

inorganic compounds.

Among these compounds, silver and the silver compound are desirable due to its high thermal stability.

Examples of the silver compound include silver chelate and silver salts such as fatty acid salts and phosphoric acid salts and the like.

If silver and the silver compound are used as an antibacterial agent or an antifungal agent, these may be used as supported on a porous structure such as zeolite, silica gel, zirconium phosphate, calcium phosphate, hydrotalcite, hydroxyapatite, calcium silicate.

Examples of other additives include a colorant, a plasticizer, an anti-aging agent, and oils.

Compositional Ratio of Raw Materials:

The compositional ratio of the thermoplastic resin (A) and the polyolefin wax (B) which are together used as a raw material is not particularly limited as long as the properties of the molded product to be obtained are not impaired, but the ratio is in the range of usually 0.01 to 20 parts by weight, preferably 0.1 to 10 parts by weight, and more preferably 0.3 to 5 parts by weight, to 100 parts by weight of the thermoplastic resin (A).

With the blending the polyolefin wax (B) in an amount within the above range, the effect of improving the fluidity is increased, and the molding rate is also greatly improved. Further, the molding can be effected at a low molding temperature, thus leading to a reduced cooling time, and an improved molding cycle, as well as to suppression of thermal deterioration of the resin, and thus suppression of reduction in the rigidity of the resin and of burning or black speck of the resin.

When a polyolefin resin as the thermoplastic resin (A) and a polyethylene wax as the polyolefin wax (B) are used, the ratio of blending the polyolefin resin and the polyethylene wax is not particularly limited as long as the properties of the molded product to be obtained are not impaired, but the ratio is in the range of usually 0.01 to 10 parts by weight, and preferably 2 to 3 parts by weight, to 100 parts by weight of the polyolefin resin.

With the use of the polyolefin resin and the polyethylene wax in a compositional ratio within the above range, the effect of improving the fluidity is increased, and the molding rate is also greatly improved, thereby more likely giving the improved productivity. Also, the mechanical properties originally possessed by the polyolefin resin are unlikely deteriorated. Further, the molding can be effected at a lower molding temperature as compared to the case where the blow molding is carried out without adding the polyethylene wax, thus leading to a reduced cooling time, as well as to suppression of thermal deterioration of the resin, and thus suppression of reduction in the rigidity of the resin and of burning or black speck of the resin.

Blow Molding:

In the process for producing the molded product of the invention, the above-mentioned raw materials are subjected to blow molding.

The blow molding process is not particularly limited, but examples include extrusion blow molding, injection blow molding, and the like.

When performing the extrusion blow molding, the process usually comprises melting the mixture of the thermoplastic resin such as a polyolefin resin and the polyethylene wax; extruding the molten mixture to a parison or a sheet; and blow molding the parison or the sheet using a blow molding machine.

When performing the injection blow molding, the process usually comprises melting the mixture of the thermoplastic resin such as a polyolefin resin and the polyethylene wax; injection molding the molten mixture to a tubular molded product; and blow molding the tubular molded product while blowing the air.

For example, if the molded product of the present invention is obtained by extrusion blow molding, a molded product is obtained usually by melting the mixture of the thermoplastic resin (A) and the polyolefin wax (B); extruding the mixture to a tubular parison from a die at a resin temperature in the range of usually 170 to 240° C.; holding the parison in the mold having a desired shape; blowing air; and attaching to a mold usually at a resin temperature in the range of 160 to 230° C. Further, drawing can be effected at a ratio suitable for extrusion blow molding.

If the extrusion blow molding is effected using a high-density polyethylene as the thermoplastic resin (A), a molded product is obtained by extruding the resin from a die at a resin temperature in the range of usually 170 to 220° C., preferably 180 to 210° C., and attaching to a mold at a resin temperature in the range of usually 160 to 210° C., preferably 170 to 200° C. Further, drawing can be effected upon extrusion blow molding.

If the extrusion blow molding is effected using polypropylene as the thermoplastic resin (A), a molded product is obtained by extruding the resin from a die at a resin temperature in the range of usually 190 to 230° C., preferably 200 to 220° C., and attaching to a mold at a resin temperature in the range of usually 180 to 220, preferably 190 to 210° C. Further, drawing can be effected upon extrusion blow molding.

In the case where polyethylene is used as the thermoplastic resin (A), it is preferable that the mold temperature is set in the range of 20 to 50° C., and the blow molding is subjected under the conditions of a molding temperature in the range of 150 to 200° C. and a pressure of air blowing in the range of 0.3 to 0.8 (MPa).

In the case where polyethylene is used as the thermoplastic resin (A), polyethylene with smaller MI value is preferably used from the viewpoint of suppressing drawdown upon blow molding. In a case where a die swelling is likely to occur, a molding machine having a side-feed type head may be used.

In the case where polypropylene is used as the thermoplastic resin (A), it is preferable that the mold temperature is set in the range of 20 to 50° C., and the blow molding is subjected under the conditions of a molding temperature in the range of 190 to 260° C. and a pressure of air blowing in the range of 0.3 to 0.6 (MPa).

In the case where polypropylene is used as the thermoplastic resin (A), the molding temperature is preferably 240° C. or below from the viewpoint of controlling the heat decomposition of the polypropylene. Further, from the viewpoint of providing a better impact resistance to the molded product to be obtained, a propylene block copolymer and a propylene random copolymer are preferably used among polypropylenes.

As such, for example, molded products which can be used for bottles for cosmetics, bottles for detergents, bottles for bath detergent, bottles for industrial chemicals, drums, tanks, architectural materials such as external walls, automobile parts such as automobile exterior parts, industrial machinery parts, and electric and electronic parts are obtained.

### EXAMPLES

Hereinbelow, the present invention will be explained in more detail with reference to the following Examples, but it should be construed that the invention is in no way limited to those examples.

The properties of polyethylene waxes in Examples were measured in the following manner.

Number-Average Molecular Weight (Mn):

The number-average molecular weight (Mn) was determined by GPC measurement. The conditions for the measurement are the followings. The number-average molecular weight (Mn) was determined with the use of a calibration curve obtained by using commercially available monodispersed polystyrene as a standard according to the following calibration method.

Device: Alliance Gel Permeation Chromatography, GPC 2000 (manufactured by Waters)

Solvent: o-dichlorobenzene

Column: TSKgel column×4 (manufactured by Tosoh Co., Ltd)

Flow rate: 1.0 ml/min

Sample: 0.15 mg/ml o-dichlorobenzene solution

Temperature: 140° C.

Molecular weight Conversion: in terms of PE/universal calibration method

For the universal calibration method, the following coefficients of Mark-Houwink viscosity equations were used. The coefficient of polystyrene (PS): KPS=1.38×10⁻⁴, aPS=0.70 The coefficient of polyethyrene (PE): KPE=5.06×10⁻⁴, aPE=0.70

A Value and B Value:

The proportion of components having the molecular weight of 1,000 or less was obtained in weight% from the above GPC measurement results, as the A value. The proportion of components having the molecular weight of 20,000 or more was obtained in weight% from the above GPC measurement results, as the B value.

Melt Viscosity:

The melt viscosity was measured using a Brookfield viscometer at 140° C.

Density:

The density was measured by a density gradient tube process in accordance with JIS K7112.

Melting Point:

The melting point was measured by a differential scanning calorimetry (DSC) [DSC-20, Seiko Electric Industry Co.]. First, the sample to be measured was heated to 200° C. and kept for 5 minutes, and then instantly cooled back to room temperature. About 10 mg of this sample was taken and subjected to DSC measurement while heating at a rate of 10° C./min in the temperature range of −20 to 200° C. The value of endothermic peak on the curve given from the measurement result was obtained as a melting point.

Crystallization Temperature:

The crystallization temperature (Tc, ° C.) was measured in accordance with ASTM D 3417-75 under a condition of temperature lowering rate of 2° C./min.

The properties of polyolefin resins in Examples were measured in the following manner.

MI:

in case of polyethylene: measured in accordance with JIS K7210 under conditions of a temperature of 190° C. and a test load of 21.18 N

in case of polypropylene: measured in accordance with JIS K7210 under conditions of a temperature of 230° C. and a test load of 21.18 N.

Density:

The density is measured by a density gradient tube process in accordance with JIS K7112.

The properties of the polyethylene wax used in the invention are arranged in Table 1. The 30200BT was synthesized by a catalyst comprising the metallocene compound represented in the Example 1 of metallocene compound.

TABLE 1
Polyolefin Wax
Values of Properties

| | | | | | | | | | | | Value |
|---|---|---|---|---|---|---|---|---|---|---|---|
| | | | | | | | | | DSC | | of left |
| | | | | Melting | B | A | | | melting | Crystallization | side in |
| | | | Density | viscosity | value | value | | | point | Temperature | Formula |
| | Mn | Mw | (kg/m³) | K (mPa · s) | (wt %) | (wt) | 0.0075 × K | 230 × K^{-0.537} | (° C.) | (° C.) | (III) |
| 30200BT | 2000 | 5000 | 913 | 300 | 2.2 | 9.3 | 2.3 | 10.8 | 98.2 | 86.6 | 91.41 |
| 40800T | 2400 | 7000 | 980 | 600 | 4.2 | 7.3 | 4.5 | 7.4 | 127.7 | 116.2 | 124.98 |

The properties of molded products in Examples were measured in the following manner.

Productivity:

The number of shots per an hour unit upon blow molding and the molding cycle period were evaluated:

Number of Shots

The number of shots was determined from the number of the bottles prepared within 1 hour

Molding Cycle Period

The molding cycle was determined from the time taken for the preparation of one bottle.

Mechanical Properties:

The dropping test was carried out under the following conditions for evaluation:

Dropping Test

A predetermined amount of water was poured into bottles having an inner volume of 2000 ml, 1500 ml, or 1000 ml, which are prepared under conditions described in Examples and Comparative Examples, and the each bottle was dropped from a predetermined height. At this time, a number of bottles whitened or cracked were determined for evaluation.

For the bottle having an inner volume of 2000 ml: the amount of water added is 1500 ml, and the height for the test is 1.5 m.

For the bottle having an inner volume of 1500 ml: the amount of water added is 800 ml, and the height for the test is 1.2 m.

For the bottle having an inner volume of 1000 ml: the amount of water added is 600 ml, and the height for the test is 1.2 m.

Appearance:

The appearance of the bottles was observed with eyes, and evaluated using the following standards.

A: Thickness is uniform.

B: Thickness non-uniformity is prominent.

C: Thickness non-uniformity is considerably prominent.

### Example 1

100 parts by mass of a propylene homopolymer (Prime Polypro E111G; produced by Prime Polymer Co., Ltd., density=910 (kg/m³), MI=0.5 g/10 min) and 2 parts by mass of a metallocene polyethylene wax (Excerex 30200 BT, manufactured by Mitsui Chemical Inc., content of ethylene: 95 mol %, density: 913 kg/m³, Mn=2,000, A value=9.3, B value=2.2, melt viscosity=300 (mPa·s)) were thoroughly mixed in a tumbler mixer. Subsequently, the molding temperature of the blow molding machine (direct mode (1 parison-1 mold mode), JB 105 hollow molding machine manufactured by Japan Steel Works, LTD.; a screw diameter of molding machine of +50 mm, L/D=22, a compression ratio of 1.3, a die diameter of φ 82 mm (core size of φ 78 mm)) was set to 190° C. and the mold temperature was set to 20° C. The obtained mixture was added to the molding machine and subjected to melt-kneading at a screw rotating speed of 30 rpm, followed by blow molding under the air-blowing pressure of 0.5 MPa, to prepare a bottle having an inner volume of 2000 ml. The output upon molding was 23.8 (kg/h) and the temperature of outputted resin (parison) was 198° C. The weight of the molded article obtained was 200±2.0 g, and its appearance was excellent. In the dropping test (amount of water added was 1500 ml and the height for testing was 1.5 m), the bottles were not at all whitened or cracked. The results are shown in Table 2.

### Example 2

The blow molding was carried out in the same manner as in Example 1, except that the amount of the metallocene polyethylene wax (Excerex 30200 BT, manufactured by Mitsui Chemical Inc.) added was changed to 3 parts by mass. The output upon molding was 26.0 (kg/h) and the temperature of outputted resin (parison) was 196° C. The weight of the molded article obtained was 200±2.0 g, and its appearance was excellent. In the dropping test (amount of water added was 1500 ml and the height for testing was 1.5 m), the bottles were not at all whitened or cracked. The results are shown in Table 2.

### Comparative Example 1

The molding temperature of the blow molding machine (direct mode (1 parison-1 mold mode), JB 105 hollow molding machine manufactured by Japan Steel Works, LTD.; a screw diameter of molding machine of φ 50 mm, L/D=22, a compression ratio of 1.3, a die diameter of φ 82 mm (core size of φ 78 mm)) was set to 210° C. and the mold temperature was set to 20° C. A propylene homopolymer (Prime Polypro E111G; produced by Prime Polymer Co., Ltd., density=910 (kg/M³), MI=0.5 g/10 min) was added to the machine, then melt-kneaded at a screw rotating speed of 30 rpm, followed by blow molding under the air-blowing pressure of 0.5 MPa, to prepare a bottle having an inner volume of 2000 ml. The output upon molding was 20.0 (kg/h) and the temperature of outputted resin (parison) was 218° C. The weight of the molded article obtained was 200±2.0 g, and its appearance was excellent. In the dropping test (amount of water added was 1500 ml and the height for testing was 1.5 m), excellent results were obtained, but the number of shots was lessened although the molding temperature had been increased by 30° C. as compared to the Examples, as well as the molding cycle was longer, thus the productivity being poor. The results are shown in Table 2.

### Comparative Example 2

The molding temperature of the blow molding machine (direct mode (1 parison-1 mold mode), JB 105 hollow molding machine manufactured by Japan Steel Works, LTD.; a screw diameter of molding machine of φ 50 mm, L/D=22, a compression ratio of 1.3, a die diameter of φ 82 mm (core size of φ 78 mm)) was set to 190° C. and the mold temperature was set to 20° C. A propylene homopolymer (Prime Polypro E111G; produced by Prime Polymer Co., Ltd., density=910 (kg/m³), MI=0.5 g/10 min) was added to the machine, then melt-kneaded at a screw rotating speed of 30 rpm, followed by blow molding under the air-blowing pressure of 0.5 MPa, to prepare a bottle having an inner volume of 2000 ml. The output upon molding was 16.1 (kg/h) and the temperature of outputted resin (parison) was 191° C. A considerably non uniform thickness was observed in the obtained molded article resulting in a poor appearance, and also whitened or cracked bottles were observed in the dropping test (amount of water added was 1500 ml and the height for testing was 1.5 m). As compared to the Examples, the number of shots was lessened, as well as the molding cycle was longer, thus the productivity being poor. The results are shown in Table 2.

TABLE 2

| | | Example/Comparative Example No. | | | |
|---|---|---|---|---|---|
| | | | | Comparative | Comparative |
| | | Example 1 | Example 2 | Example 1 | Example 2 |
| Polypropylene | Kind | E111G | E111G | E111G | E111G |
| | Amount | 100 | 100 | 100 | 100 |
| Polyethylene wax | Kind | 30200 BT | 30200 BT | | |
| | Amount | 2 | 3 | | |
| Molding Temperature | ° C. | 190 | 190 | 210 | 190 |
| Output | kg/h | 23.8 | 26.0 | 20.0 | 16.1 |
| Resin Temperature | ° C. | 198 | 196 | 218 | 191 |
| Number of Shots | bottle/h | 75 | 80 | 62 | 49 |
| Molding Cycle Period | sec | 48 | 45 | 58 | 73 |
| Weight of molded article | g | 200.2 | 200.1 | 200.0 | 190.5 |
| Appearance of molded article | | A | A | A | C |
| Amount of Water filled | g | 2239 | 2238 | 2239 | 2209 |
| Dropping Test | bottle/10 bottles | 0 | 0 | 0 | 6 |

### Example 3

100 parts by mass of a propylene block copolymer (Prime Polypro B 701WB; produced by Prime Polymer Co., Ltd., density=920 (kg/m³), MI=0.5 g/10 min) and 2 parts by mass of a metallocene polyethylene wax (Excerex 30200 BT, manufactured by Mitsui Chemical Inc., content of ethylene: 95 mol %, density: 913 kg/m³, Mn=2,000, A value=9.3, B value=2.2, melt viscosity=300 (mPa·s)) were thoroughly mixed in a tumbler mixer. Subsequently, the molding temperature of the blow molding machine (direct mode (1 parison-1 mold mode), JB 105 hollow molding machine manufactured by Japan Steel Works, LTD.; a screw diameter of molding machine of φ 50 mm, L/D=22, a compression ratio of 1.3, a die diameter of φ 82 mm (core size of φ 78 mm)) was set to 190° C. and the mold temperature was set to 20° C. The obtained mixture was added to the molding machine and subjected to melt-kneading at a screw rotating speed of 30 rpm, followed by blow molding under the air-blowing pressure of 0.5 MPa, to prepare a bottle having an inner volume of 2000 ml. The output upon molding was 25.2 (kg/h) and the temperature of outputted resin (parison) was 198° C. The weight of the molded article obtained was 200±3.0 g, and its appearance was excellent. In the dropping test (amount of water added was 1500 ml and the height for testing was 1.5 m), the bottles were not at all whitened or cracked. The results are shown in Table 3.

### Example 4

The blow molding was carried out in the same manner as in Example 3, except that the amount of the metallocene polyethylene wax (Excerex 30200 BT, manufactured by Mitsui Chemical Inc.) added was changed to 3 parts by mass. The output upon molding was 27.3 (kg/h) and the temperature of outputted resin (parison) was 196° C. The weight of the molded article obtained was 200±3.0 g, and its appearance was excellent. In the dropping test (amount of water added was 1500 ml and the height for testing was 1.5 m), the bottles were not at all whitened or cracked. The results are shown in Table 3.

### Comparative Example 3

The molding temperature of the blow molding machine (direct mode (1 parison-1 mold mode), JB 105 hollow molding machine manufactured by Japan Steel Works, LTD.; a screw diameter of molding machine of φ 50 mm, L/D=22, a compression ratio of 1.3, a die diameter of φ 82 mm (core size of φ 78 mm)) was set to 210° C. and the mold temperature was set to 20° C. A polypropylene block copolymer (Prime Polypro B701WB; produced by Prime Polymer Co., Ltd., density=920 (kg/m³), MI=0.5 g/10 min) was added to the machine, then melt-kneaded at a screw rotating speed of 30 rpm, followed by blow molding under the air-blowing pressure of 0.5 MPa, to prepare a bottle having an inner volume of 2000 ml. The output upon molding was 21.0 (kg/h) and the temperature of outputted resin (parison) was 219° C. The weight of the molded article obtained was 200±3.0 g, and its appearance was excellent. In the dropping test (amount of water added was 1500 ml and the height for testing was 1.5 m), excellent results were obtained, but the number of shots was lessened although the molding temperature had been increased by 30° C. as compared to the Examples, as well as the molding cycle was longer, thus the productivity being poor. The results are shown in Table 3.

### Comparative Example 4

The molding temperature of the blow molding machine (direct mode (1 parison-1 mold mode), JB 105 hollow molding machine manufactured by Japan Steel Works, LTD.; a screw diameter of molding machine of φ 50 mm, L/D=22, a compression ratio of 1.3, a die diameter of φ 82 mm (core size of φ 78 mm)) was set to 190° C. and the mold temperature was set to 20° C. A polypropylene block copolymer (Prime Polypro B701WB; produced by Prime Polymer Co., Ltd., density=920 (kg/m³), MI=0.5 g/10 min) was added to the machine, then melt-kneaded at a screw rotating speed of 30 rpm, followed by blow molding under the air-blowing pressure of 0.5 MPa, to prepare a bottle having an inner volume of 2000 ml. The output upon molding was 16.8 (kg/h) and the temperature of outputted resin (parison) was 192° C. A considerably non uniform thickness was observed in the obtained molded article resulting in a poor appearance, and also whitened or cracked bottles were observed in the dropping test (amount of water added was 1500 ml and the height for testing was 1.5 m). As compared to the Examples, the number of shots was lessened, as well as the molding cycle was longer, thus the productivity being poor. The results are shown in Table 3.

TABLE 3

| | | Example/Comparative Example No. | | | |
|---|---|---|---|---|---|
| | | | | Comparative | Comparative |
| | | Example 3 | Example 4 | Example 3 | Example 4 |
| Polypropylene | Kind | B701WB | B701WB | B701WB | B701WB |
| | Amount | 100 | 100 | 100 | 100 |
| Polyethylene wax | Kind | 30200 BT | 30200 BT | | |
| | Amount | 2 | 3 | | |
| Molding Temperature | ° C. | 190 | 190 | 210 | 190 |
| Output | kg/h | 25.2 | 27.3 | 21.0 | 16.8 |
| Resin Temperature | ° C. | 198 | 196 | 219 | 192 |
| Number of Shots | bottle/h | 70 | 76 | 59 | 47 |
| Molding Cycle Period | sec | 51 | 47 | 61 | 76 |
| Weight of molded article | g | 200.2 | 199.8 | 200.0 | 189.8 |
| Appearance of molded article | | A | A | A | C |
| Amount of Water filled | g | 2239 | 2237 | 2238 | 2213 |
| Dropping Test | bottle/10 bottles | 0 | 0 | 0 | 4 |

### Example 5

100 parts by mass of a propylene random copolymer (Prime Polypro B211WA; produced by Prime Polymer Co., Ltd., density=910 (kg/M³), MI=0.5 g/10 min) and 2 parts by mass of a metallocene polyethylene wax (Excerex 30200 BT, manufactured by Mitsui Chemical Inc., content of ethylene: 95 mol %, density: 913 kg/m³, Mn=2,000, A value=9.3, B value=2.2, melt viscosity=300 (mPa·s)) were thoroughly mixed in a tumbler mixer. Subsequently, the molding temperature of the blow molding machine (1 parison-2 mold mode, JEB 15 blow molding machine manufactured by Japan Steel Works, LTD.; a screw diameter of molding machine of φ 50 mm, L/D=28, a compression ratio of 1.3, a die diameter of φ 45 mm (core size of φ 40 mm)) was set to 180° C. and the mold temperature was set to 25° C. The obtained mixture was added to the molding machine and subjected to melt-kneading at a screw rotating speed of 40 rpm, followed by blow molding under the air-blowing pressure of 0.5 MPa, to prepare a bottle having an inner volume of 1500 ml. The output upon molding was 20.6 (kg/h) and the temperature of outputted resin (parison) was 187° C. The weight of the molded article obtained was 80±2.5 g, and its appearance was excellent. In the dropping test (amount of water added was 800 ml and the height for testing was 1.2 m), the bottles were not at all whitened or cracked. The results are shown in Table 4.

### Example 6

The blow molding was carried out in the same manner as in Example 1, except that the amount of the metallocene polyethylene wax (Excerex 30200 BT, manufactured by Mitsui Chemical Inc.) added was changed to 3 parts by mass. The output upon molding was 21.3 (kg/h) and the temperature of outputted resin (parison) was 186° C. The weight of the molded article obtained was 80±2.5 g, and its appearance was excellent. In the dropping test (amount of water added was 800 ml and the height for testing was 1.2 m), the bottles were not at all whitened or cracked. The results are shown in Table 4.

### Comparative Example 5

The molding temperature of the blow molding machine (1 parison-2 mold mode, JEB 15 blow molding machine manufactured by Japan Steel Works, LTD.; a screw diameter of molding machine of φ 50 mm, L/D=28, a compression ratio of 1.3, a die diameter of φ 45 mm (core size of φ 40 mm)) was set to 200° C. and the mold temperature was set to 25° C. A propylene random copolymer (Prime Polypro B211WA; produced by Prime Polymer Co., Ltd., density=910 (kg/m³), MI=0.5 g/10 min) was added to the machine, then melt-kneaded at a screw rotating speed of 40 rpm, followed by blow molding under the air-blowing pressure of 0.5 MPa, to prepare a bottle having an inner volume of 1500 ml. The output upon molding was 16.0 (kg/h) and the temperature of outputted resin (parison) was 206° C. The weight of the molded article obtained was 80±2.5 g, and its appearance was excellent. In the dropping test (amount of water added was 800 ml and the height for testing was 1.2 m), excellent results were obtained, but the number of shots was lessened although the molding temperature had been increased by 20° C. as compared to the Examples, as well as the molding cycle was longer, thus the productivity being poor. The results are shown in Table 4.

### Comparative Example 6

The molding temperature of the blow molding machine (1 parison-2 mold mode, JEB 15 blow molding machine manufactured by Japan Steel Works, LTD.; a screw diameter of molding machine of φ 50 mm, L/D=28, a compression ratio of 1.3, a die diameter of φ 45 mm (core size of φ 40 mm)) was set to 180° C. and the mold temperature was set to 25° C. A propylene random copolymer (Prime Polypro B211WA; produced by Prime Polymer Co., Ltd., density=910 (kg/m³), MI=0.5 g/10 min) was added to the machine, then melt-kneaded at a screw rotating speed of 40 rpm, followed by blow molding under the air-blowing pressure of 0.5 MPa, to prepare a bottle having an inner volume of 1500 ml. The output upon molding was 13.8 (kg/h) and the temperature of outputted resin (parison) was 181° C. A considerably non uniform thickness was observed in the obtained molded article resulting in a poor appearance, and also whitened or cracked bottles were observed in the dropping test (amount of water added was 800 ml and the height for testing was 1.2 m). As compared to the Examples, the number of shots was lessened, as well as the molding cycle was longer, thus the productivity being poor. The results are shown in Table 4.

TABLE 4

| | | Example/Comparative Example No. | | | |
|---|---|---|---|---|---|
| | | | | Comparative | Comparative |
| | | Example 5 | Example 6 | Example 5 | Example 6 |
| Polypropylene | Kind | B211WA | B211WA | B211WA | B211WA |
| | Amount | 100 | 100 | 100 | 100 |
| Polyethylene wax | Kind | 30200 BT | 30200 BT | | |
| | Amount | 2 | 3 | | |
| Molding Temperature | ° C. | 180 | 180 | 200 | 180 |
| Output | kg/h | 20.6 | 21.3 | 16.0 | 13.8 |
| Resin Temperature | ° C. | 187 | 186 | 206 | 181 |
| Number of Shots | bottle/h | 259 | 264 | 202 | 174 |
| Molding Cycle Period | sec | 28 | 27 | 36 | 41 |
| Weight of molded article | g | 80.7 | 81.3 | 79.6 | 78.2 |
| Appearance of molded article | | A | A | A | C |
| Amount of Water filled | g | 1674 | 1674 | 1673 | 1669 |
| Dropping Test | bottle/10 bottles | 0 | 0 | 0 | 7 |

### Example 7

100 parts by mass of a high-density polyethylene (Hi-Zex 5100B; produced by Prime Polymer Co., Ltd., density =944 (kg/m³), MI=0.27 g/10 min) and 2 parts by mass of a metallocene polyethylene wax (Excerex 40800 T, manufactured by Mitsui Chemical Inc., content of ethylene: 100 mol %, density: 980 kg/m³, Mn=2,400, A value=7.3, B value=4.2, melt viscosity=600 (mPa·s)) were thoroughly mixed in a tumbler mixer. Subsequently, the molding temperature of the blow molding machine (1 parison-1 mold mode, 3B50 hollow molding machine manufactured by Placo Co. Ltd.; a screw diameter of molding machine of φ 50 mm, L/D=30, a compression ratio of 1.3, a die diameter of φ 46 mm (core size of φ 42 mm)) was set to 150° C. and the mold temperature was set to 25° C. The obtained mixture was added to the molding machine and subjected to melt-kneading at a screw rotating speed of 50 rpm, followed by blow molding under the air-blowing pressure of 0.5 MPa, to prepare a bottle having an inner volume of 1000 ml. The output upon molding was 8.7 (kg/h) and the temperature of outputted resin (parison) was 158° C. The weight of the molded article obtained was 67±2 g, and its appearance was excellent. In the dropping test (amount of water added was 600 ml and the height for testing was 1.2 m), the bottles were not at all whitened or cracked. The results are shown in Table 5.

### Example 8

The blow molding was carried out in the same manner as in Example 1, except that the amount of the metallocene polyethylene wax (Excerex 40800 T, manufactured by Mitsui Chemical Inc.) added was changed to 3 parts by mass. The output upon molding was 9.0 (kg/h) and the temperature of outputted resin (parison) was 157° C. The weight of the molded article obtained was 67±2 g, and its appearance was excellent. In the dropping test (amount of water added was 600 ml and the height for testing was 1.2 m), the bottles were not at all whitened or cracked. The results are shown in Table 5.

### Comparative Example 7

The molding temperature of the blow molding machine (1 parison-1 mold mode, 3B50 hollow molding machine manufactured by Placo Co. Ltd.; a screw diameter of molding machine of φ 50 mm, L/D=30, a compression ratio of 1.3, a die diameter of φ 46 mm (core size of φ 42 mm)) was set to 170° C. and the mold temperature was set to 25° C. A high-density polyethylene (Hi-Zex 5100B; produced by Prime Polymer Co., Ltd., density=944 (kg/m³), MI=0.27 g/10 min) was added to the machine, then melt-kneaded at a screw rotating speed of 50 rpm, followed by blow molding under the air-blowing pressure of 0.5 MPa, to prepare a bottle having an inner volume of 1000 ml. The output upon molding was 6.7 (kg/h) and the temperature of outputted resin (parison) was 178° C. The weight of the molded article obtained was 67±2 g, and its appearance was excellent. In the dropping test (amount of water added was 600 ml and the height for testing was 1.2 m), excellent results were obtained, but the number of shots was lessened although the molding temperature had been increased by 20° C. as compared to the Examples, as well as the molding cycle was longer, thus the productivity being poor. The results are shown in Table 5.

### Comparative Example 8

The molding temperature of the blow molding machine (1 parison-1 mold mode, 3B50 hollow molding machine manufactured by Placo Co. Ltd.; a screw diameter of molding machine of φ 50 mm, L/D=30, a compression ratio of 1.3, a die diameter of φ 46 mm (core size of φ 42 mm)) was set to 150° C. and the mold temperature was set to 25° C. A high-density polyethylene (Hi-Zex 5100B; produced by Prime Polymer Co., Ltd., density=944 (kg/m³), MI=0.27 g/10 min) was added to the machine, then melt-kneaded at a screw rotating speed of 50 rpm, followed by blow molding under the air-blowing pressure of 0.5 MPa, to prepare a bottle having an inner volume of 1000 ml. The output upon molding was 5.2 (kg/h) and the temperature of outputted resin (parison) was 152° C. A considerably non uniform thickness was observed in the obtained molded article resulting in a poor appearance, and also whitened or cracked bottles were observed in the dropping test (amount of water added was 600 ml and the height for testing was 1.2 m). As compared to the Examples, the number of shots was lessened, as well as the molding cycle was longer, thus the productivity being poor. The results are shown in Table 5.

TABLE 5

| | | Example/Comparative Example No. | | | |
|---|---|---|---|---|---|
| | | | | Comparative | Comparative |
| | | Example 7 | Example 8 | Example 7 | Example 8 |
| Polyethylene | Kind | 5100B | 5100B | 5100B | 5100B |
| | Amount | 100 | 100 | 100 | 100 |
| Polyethylene wax | Kind | 40800 T | 40800 T | | |
| | Amount | 2 | 3 | | |
| Molding Temperature | ° C. | 150 | 150 | 170 | 150 |
| Output | kg/h | 8.7 | 9 | 6.7 | 5.2 |
| Resin Temperature | ° C. | 158 | 157 | 178 | 152 |
| Number of Shots | bottle/h | 149 | 151 | 113 | 93 |
| Molding Cycle Period | sec | 24 | 24 | 32 | 39 |
| Weight of molded article | g | 67.3 | 67.6 | 66.8 | 65.7 |
| Appearance of molded article | | A | A | A | C |
| Amount of Water filled | g | 1131 | 1131 | 1130 | 1126 |
| Dropping Test | bottle/10 bottles | 0 | 0 | 0 | 9 |

### Example 9

100 parts by mass of a low-density polyethylene (MIRASON 50; produced by Prime Polymer Co., Ltd., density=920 (kg/m³), MI=1.9 g/10 min) and 2 parts by mass of a metallocene polyethylene wax (Excerex 30200 BT, manufactured by Mitsui Chemical Inc., content of ethylene: 95 mol %, density: 913 kg/m³, Mn=2,000, A value=9.3, B value=2.2, melt viscosity=300 (mPa·s)) were thoroughly mixed in a tumbler mixer. Subsequently, the molding temperature of the blow molding machine (direct mode (1 parison-1 mold mode), JB105 hollow molding machine manufactured by Japan Steel Works, LTD.; a screw diameter of molding machine of φ 50 mm, L/D=22, a compression ratio of 1.3, a die diameter of φ 82 mm (core size of φ 78 mm)) was set to 180° C. and the mold temperature was set to 20° C. The obtained mixture was added to the molding machine and subjected to melt-kneading at a screw rotating speed of 30 rpm, followed by blow molding under the air-blowing pressure of 0.5 MPa, to prepare a bottle having an inner volume of 2000 ml. The output upon molding was 27.5 (kg/h) and the temperature of outputted resin (parison) was 188° C. The weight of the molded article obtained was 200±3.0 g, and its appearance was excellent. In the dropping test (amount of water added was 1500 ml and the height for testing was 1.5 m), the bottles were not at all whitened or cracked. The results are shown in Table 6.

### Example 10

The blow molding was carried out in the same manner as in Example 3, except that the amount of the metallocene polyethylene wax (Excerex 30200 BT, manufactured by Mitsui Chemical Inc.) added was changed to 3 parts by mass. The output upon molding was 30.0 (kg/h) and the temperature of outputted resin (parison) was 187° C. The weight of the molded article obtained was 200±3.0 g, and its appearance was excellent. In the dropping test (amount of water added was 1500 ml and the height for testing was 1.5 m), the bottles were not at all whitened or cracked. The results are shown in Table 6.

### Comparative Example 9

The molding temperature of the blow molding machine (direct mode (1 parison-1 mold mode), JB 105 hollow molding machine manufactured by Japan Steel Works, LTD.; a screw diameter of molding machine of φ 50 mm, L/D=22, a compression ratio of 1.3, a die diameter of φ 82 mm (core size of φ 78 mm)) was set to 200° C. and the mold temperature was set to 20° C. A low-density polyethylene (MIRASON 50; produced by Prime Polymer Co., Ltd., density=920 (kg/m³), MI=1.9 g/10 min) was added to the machine, then melt-kneaded at a screw rotating speed of 30 rpm, followed by blow molding under the air-blowing pressure of 0.5 MPa, to prepare a bottle having an inner volume of 2000 ml. The output upon molding was 25.0 (kg/h) and the temperature of outputted resin (parison) was 208° C. The weight of the molded article obtained was 200±3.0 g, and its appearance was excellent. In the dropping test (amount of water added was 1500 ml and the height for testing was 1.5 m), excellent results were obtained, but the number of shots was lessened although the molding temperature had been increased by 20° C. as compared to the Examples, as well as the molding cycle was longer, thus the productivity being poor. The results are shown in Table 6.

### Comparative Example 10

The molding temperature of the blow molding machine (direct mode (1 parison-1 mold mode), JB 105 hollow molding machine manufactured by Japan Steel Works, LTD.; a screw diameter of molding machine of φ 50 mm, L/D=22, a compression ratio of 1.3′, a die diameter of φ 82 mm (core size of φ 78 mm)) was set to 180° C. and the mold temperature was set to 20° C. A low-density polyethylene (MIRASON 50; produced by Prime Polymer Co., Ltd., density=920 (kg/m³), MI=1.9 g/10 min) was added to the machine, then melt-kneaded at a screw rotating speed of 30 rpm, followed by blow molding under the air-blowing pressure of 0.5 MPa, to prepare a bottle having an inner volume of 2000 ml. The output upon molding was 22.5 (kg/h) and the temperature of outputted resin (parison) was 181° C. A considerably non uniform thickness was observed in the obtained molded article resulting in a poor appearance, and also whitened or cracked bottles were observed in the dropping test (amount of water added was 1500 ml and the height for testing was 1.5 m). As compared to the Examples, the number of shots was lessened, as well as the molding cycle was longer, thus the productivity being poor. The results are shown in Table 6.

TABLE 6

| | | Example/Comparative Example No. | | | |
|---|---|---|---|---|---|
| | | | | Comparative | Comparative |
| | | Example 9 | Example 10 | Example 9 | Example 10 |
| Polyethylene | Kind | MIRASON 50 | MIRASON 50 | MIRASON 50 | MIRASON 50 |
| | Amount | 100 | 100 | 100 | 100 |
| Polyethylene wax | Kind | 30200 BT | 30200 BT | | |
| | Amount | 2 | 3 | | |
| Molding Temperature | ° C. | 180 | 180 | 200 | 180 |
| Output | kg/h | 27.5 | 30.0 | 25.0 | 22.5 |
| Resin Temperature | ° C. | 188 | 187 | 208 | 181 |
| Number of Shots | bottle/h | 80 | 85 | 72 | 65 |
| Molding Cycle Period | sec | 45 | 41 | 50 | 55 |
| Weight of molded article | g | 201.8 | 202.2 | 202 | 191.5 |
| Appearance of molded article | | A | A | A | C |
| Amount of Water filled | g | 2234 | 2232 | 2237 | 2208 |
| Dropping Test | bottle/10 bottles | 0 | 0 | 0 | 5 |

### Example 11

100 parts by mass of a linear low-density polyethylene (ULTZEX 2020SB; produced by Prime Polymer Co., Ltd., density=920 (kg/m³), MI=1.6 g/10 min) and 2 parts by mass of a metallocene polyethylene wax (Excerex 30200 BT, manufactured by Mitsui Chemical Inc., content of ethylene: 95 mol %, density: 913 kg/m³, Mn=2,000, A value=9.3, B value=2.2, melt viscosity=300 (mPa·s)) were thoroughly mixed in a tumbler mixer. Subsequently, the molding temperature of the blow molding machine (direct mode (1 parison-1 mold mode), JB105 hollow molding machine manufactured by Japan Steel Works, LTD.; a screw diameter of molding machine of φ 50 mm, L/D=22, a compression ratio of 1.3, a die diameter of φ 82 mm (core size of φ 78 mm)) was set to 180° C. and the mold temperature was set to 20° C. The obtained mixture was added to the molding machine and subjected to melt-kneading at a screw rotating speed of 30 rpm, followed by blow molding under the air-blowing pressure of 0.5 MPa, to prepare a bottle having an inner volume of 2000 ml. The output upon molding was 26.4 (kg/h) and the temperature of outputted resin (parison) was 188° C. The weight of the molded article obtained was 200±3.0 g, and its appearance was excellent. In the dropping test (amount of water added was 1500 ml and the height for testing was 1.5 m), the bottles were not at all whitened or cracked. The results are shown in Table 7.

### Example 12

The blow molding was carried out in the same manner as in Example 3, except that the amount of the metallocene polyethylene wax (Excerex 30200 BT, manufactured by Mitsui Chemical Inc.) added was changed to 3 parts by mass. The output upon molding was 28.8 (kg/h) and the temperature of outputted resin (parison) was 186° C. The weight of the molded article obtained was 200±3.0 g, and its appearance was excellent. In the dropping test (amount of water added was 1500 ml and the height for testing was 1.5 m), the bottles were not at all whitened or cracked. The results are shown in Table 7.

### Comparative Example 11

The molding temperature of the blow molding machine (direct mode (1 parison-1 mold mode), JB 105 hollow molding machine manufactured by Japan Steel Works, LTD.; a screw diameter of molding machine of φ 50 mm, L/D=22, a compression ratio of 1.3, a die diameter of φ 82 mm (core size of φ 78 mm)) was set to 200° C. and the mold temperature was set to 20° C. A linear low-density polyethylene (ULTZEX 2020SB; produced by Prime Polymer Co., Ltd., density=920 (kg/m³), MI=1.6 g/10 min) was added to the machine, then melt-kneaded at a screw rotating speed of 30 rpm, followed by blow molding under the air-blowing pressure of 0.5 MPa, to prepare a bottle having an inner volume of 2000 ml. The output upon molding was 24.0 (kg/h) and the temperature of outputted resin (parison) was 207° C. The weight of the molded article obtained was 200±3.0 g, and its appearance was excellent. In the dropping test (amount of water added was 1500 ml and the height for testing was 1.5 m), excellent results were obtained, but the number of shots was lessened although the molding temperature had been increased by 20° C. as compared to the Examples, as well as the molding cycle was longer, thus the productivity being poor. The results are shown in Table 7.

### Comparative Example 12

The molding temperature of the blow molding machine (direct mode (1 parison-1 mold mode), JB 105 hollow molding machine manufactured by Japan Steel Works, LTD.; a screw diameter of molding machine of φ 50 mm, L/D=22, a compression ratio of 1.3, a die diameter of φ 82 mm (core size of φ 78 mm)) was set to 180° C. and the mold temperature was set to 20° C. A linear low-density polyethylene (ULTZEX 2020SB; produced by Prime Polymer Co., Ltd., density=920 (kg/m³), MI=1.6 g/10 min) was added to the machine, then melt-kneaded at a screw rotating speed of 30 rpm, followed by blow molding under the air-blowing pressure of 0.5 MPa, to prepare a bottle having an inner volume of 2000 ml. The output upon molding was 21.6 (kg/h) and the temperature of outputted resin (parison) was 180° C. A considerably non uniform thickness was observed in the obtained molded article resulting in a poor appearance, and also whitened or cracked bottles were observed in the dropping test (amount of water added was 1500 ml and the height for testing was 1.5 m). As compared to the Examples, the number of shots was lessened, as well as the molding cycle was longer, thus the productivity being poor. The results are shown in Table 7.

TABLE 7
Results of Blow Molding

| | | Example/Comparative Example No. | | | |
|---|---|---|---|---|---|
| | | | | Comparative | Comparative |
| | | Example 11 | Example 12 | Example 11 | Example 12 |
| Polyethylene | Kind | 2020 SB | 2020 SB | 2020 SB | 2020 SB |
| | Amount | 100 | 100 | 100 | 100 |
| Polyethylene wax | Kind | 30200 BT | 30200 BT | | |
| | Amount | 2 | 3 | | |
| Molding Temperature | ° C. | 180 | 180 | 200 | 180 |
| Output | kg/h | 26.4 | 28.8 | 24.0 | 21.6 |
| Resin Temperature | ° C. | 188 | 186 | 207 | 180 |
| Number of Shots | bottle/h | 83 | 90 | 75 | 67 |
| Molding Cycle Period | sec | 43 | 40 | 48 | 53 |
| Weight of molded article | g | 202.1 | 201.8 | 202.2 | 190.2 |
| Appearance of molded article | | A | A | A | C |
| Amount of Water filled | g | 2236 | 2241 | 2239 | 2205 |
| Dropping Test | bottle/10 bottles | 0 | 0 | 0 | 6 |

What is claimed is:

1. A process for producing a molded product, comprising melting a mixture of a thermoplastic resin (A) and a polyolefin wax (B) which has a number-average molecular weight (Mn) in terms of polyethylene, as measured by gel permeation chromatography (GPC), in the range of 200 to 5,000, and a crystallization temperature, as measured by a differential scanning calorimetry (DSC) under the condition of a temperature lowering rate of 2° C./min, in the range of 65 to 120° C.; and then subjecting the mixture to blow molding.

2. A process for producing a molded product, comprising melting a mixture of a thermoplastic resin (A) and a polyolefin wax (B) which has a number-average molecular weight (Mn) in terms of polystyrene, as measured by gel permeation chromatography (GPC), in the range of 400 to 5,000, and a crystallization temperature, as measured by a differential scanning calorimetry (DSC) under the condition of a temperature lowering rate of 2° C./min, in the range of 65 to 120° C.; and then subjecting the mixture to blow molding.

3. The process according to claim 1, wherein the polyolefin wax (B) is a polyethylene wax.

4. The process according to claim 1, wherein the polyolefin wax (B) is a polyethylene wax obtained by using a metallocene catalyst.

5. A process for producing a molded product, comprising blow molding a mixture of a thermoplastic resin (A) and a polyethylene wax which has a density, as measured by a density gradient tube process in accordance with JIS K7112, in the range of 890 to 980 kg/m³ and a number-average molecular weight (Mn) in terms of polyethylene, as measured by gel permeation chromatography (GPC), in the range of 500 to 3,000, and satisfies the relationship shown by the following formula (I):
B≦0.0075×K (I),
wherein B is a proportion (wt%) of components contained in the polyethylene wax each having a molecular weight in terms of polyethylene, as measured by gel permeation chromatography, of 20,000 or more; and K is a melt viscosity (mPa·s) of the polyethylene wax at 140° C.

6. The process according to claim 5, wherein the polyethylene wax further satisfies the relationship shown by the following formula (II):
A≦230×K⁽⁻0.537) (II),
wherein A is a proportion (wt%) of components contained in the polyethylene wax each having a molecular weight in terms of polyethylene, as measured by gel permeation chromatography, of 1,000 or less; and K is a melt viscosity (mPa·s) of the polyethylene wax at 140° C.
